(19) United States
(12) Patent Application Publication
(10) Pub. No.: US 2005/0071142 A1
(43) Pub. Date: Mar. 31, 2005

(54) Methods for simulation of biological and/or chemical reaction pathway, biomolecules and nano-molecular systems

(75) Inventors: Yu Zong Chen, Singapore (SG); Yong Ping Xu, Singapore (SG); Jianzhong Chen, Singapore (SG)

Correspondence Address: ROTHWELL, FIGG, ERNST & MANBECK, P.C., 1425 K STREET, N.W., SUITE 800, WASHINGTON, DC, 20005, US

(73) Assignee: National University of Singapore, an organization organized existing under the laws of Singapore

(21) Appl. No.: 10/674,586

(22) Filed: Sep. 29, 2003

(51) Int. Cl. G06G 7/48; G06G 7/58

(52) U.S. Cl. 703/11; 703/12

(57) ABSTRACT

A method for simulation of at least one biological and/or chemical reaction pathway comprising: preparing a map of at least one biological and/or chemical reaction pathway; constructing at least one set of binding and reaction equation from the pathway map; constructing at least one set of concentration equation for molecules of the pathway map; constructing an electronic circuit corresponding to every set of equation; determining simulation of pathway by measuring voltage at two or more connection points of the circuit. It is also provided a method for molecular dynamics simulation of biomolecules and/or nano-molecular systems comprising: constructing at least one set of equation representing the molecular dynamics of at least one molecule of the biomolecules and/or the nano-molecular systems; constructing an electronic circuit representing every set of equation; determining molecular dynamics simulation by measuring voltage at two or more connection points of the circuit.

### FIELD OF THE INVENTION

The present invention relates to Method for simulation of biological pathways, chemical reaction pathways, biomolecules, and nano-molecular-machines by using electronic circuits.

This general field is known as “Molecular Biology” (MB), “Cell Biology” (CB), “Nano-technology” (NT), “Chemistry” (CH). When used for analysis of disease processes, this field is referred to as “Pathology”. When used for the examination of the effect of pharmaceutical agents on biological systems, this field is referred to as “Drug evaluation” (DE) or “Drug testing” (DT).

### BACKGROUND OF THE INVENTION

The Need for Simulation of Biological Pathways and Chemical Reaction pathways by a new approach

Simulation of the kinetics of biological pathways and chemical reaction pathways facilitates the understanding of biological processes, complex chemical reactions, disease processes, and the effect of mutations on biological systems. It can also be used for testing the effect of drugs/molecules on biological systems and disease processes. These are described in “Simulation of prokaryotic genetic circuits”, H. H. McAddams, and A. Arkin. Annu. Rev. Biophys. Biomol. Struct. 27, 199-224 (1998).

So far, computational methods appear to be the only practically used approach for simulation of biological pathways as described in “A mathematical model of caspase function in apoptosis”, M. Fussenegger, J. E. Bailey, and J. Varner. Nature Biotech. 18, 768-774 (2000); “Mathematical modeling of epidermal growth factor receptor signaling through the phospholipase C pathway: Mechanistic insights and predictions for molecular interventions”, J. M. Haugh, A. Wells, D. A. Lauffenburger. Biotech Bioeng 70, 225-238 (2000); “Computational analysis of biochemical systems, a practical guide for biochemists and molecular biologists”, E. O. Voit. Cambridge Press (2000). In these works, the kinetics of binding and reaction events in a pathway, under certain approximations, have also been modeled by a set of first-order linear differential equations.

The kinetics of binding and reaction events in a pathway have also been described by a set of first-order nonlinear ordinary differential equations as proposed in “Systemic properties of ensembles of metabolic networks: application of graphical and statistical methods to simple unbranched pathways”, R. Alves, and M. A. Savageau. Bioinformatics 16, 534-547 (2000); and in “Inferring qualitative relations in genetic networks and metabolic pathways”, T. Akusu, S. Miyano, and S. Kuhara. Bioinformatics 16, 727-734 (2000).

While they have been successfully used in studying individual signaling and metabolic pathways involving dozens of proteins and other molecules, in the foreseeable future, computational methods are not expected to have the capacity for simulation of large and complex pathways or multiple pathways involving hundreds or more number of proteins as described in “Metabolic networks: a signal-oriented approach to cellular models” J. W. Lengeler. Biol. Chem. 381, 991-920 (2000).

Cellular events frequently involve “crosstalk” interactions among multiple pathways that may include thousands or more proteins and other molecules, and the analysis of such complex biochemical networks is further complicated by the great number of feedback and feedforward loops and of regulatory networks involved in cellular control, as described in “Metabolic networks: a signal-oriented approach to cellular models” J. W. Lengeler. Biol. Chem. 381, 991-920 (2000) and in “Mathematical modeling of epidermal growth factor receptor signaling through the phospholipase C pathway: Mechanistic insights and predictions for molecular interventions”, J. M. Haugh, A. Wells, D. A. Lauffenburger, Biotech Bioeng 70, 225-238 (2000).

The kinetics of such a large network is described by up to thousands of first order nonlinear differential equations. Significantly more numbers of equations may be needed for simulation of cellular and multi-cellular systems.

Given that it is unlikely that the computer resource in the near future is capable of solving the “long-time” kinetics of such a large number of nonlinear equations, a new approach needs to be introduced.

The Need for Structural Optimization and Molecular Dynamics Simulation of Biomolecules and Nano-molecular-systems by a New Approach

Molecular dynamics simulation is a widely used method for simulation and modeling of structures, motions, binding, and thermodynamics of biomolecules and nano-molecular-systems. These are described in “Computer simulation of biomolecular systems: Theretical and experimental applications”, Eds. W. F. van Gunsteren, P. K. Weiner, and A. J. Wilkinson. ESCOM Leiden (1993); “Computational nanotechnology”, R. C. Merkle, Nanotechnology, 2, 134-141 (1991).; nanostructure engineering as described in “Simulated engineering of nanostructures”, D. W. Brenner, S. B. Sinnott, J. A. Harrison, and O. A. Shenderova. Nanotechnology 7 161-167 (1996). It has been used in facilitating the study of a variety of important problems such as protein folding as described in “Pathways to a protein folding intermediate observed in a 1-microsecond simulation in aqueous solution”, Y. Duan and P. A. Kollman. Science 282, 740-744 (1998); drug design as described in “Binding pathway of retinal to bacterio-opsin: A prediction by molecular dynamics simulations”, B. Isralewitz, S. Izrailev, and K. Schulten. Biophys. J. 73, 2972-2979; nanostructure engineering as described in “Simulated engineering of nanostructures”, D. W. Brenner, S. B. Sinnott, J. A. Harrison, and O. A. Shenderova. Nanotechnology 7 161-167 (1996).

Nano-molecular-systems refer to: nano-sized or nano-structured materials (such as molecular films, nanotubes, nanoscopic particles with specific electronic, optical or magnetic properties), nano-scale molecular mechanical or manufacturing systems (capable of guiding reactive molecules to 0.1 nm precision), other nano-scale devices (molecular motors, carriers, containers, pumps, circuits, tools etc.). These are described in “Nanosystems: molecular machinery, manufacturing, and computation” by K. Eric Drexler (Wiley 1992).

So far, computational methods are the only practically used approach for molecular dynamics simulation as described in “Computer simulation of biomolecular systems: Theretical and experimental applications”, Eds. W. F. van Gunsteren, P. K. Weiner, and A. J. Wilkinson. ESCOM Leiden (1993). The molecular dynamics simulation of biomolecules can be described by a set of second-order nonlinear ordinary differential equations as indicated in “A second generation force field for simulation of proteins, nucleic acids, and organic molecules”, W. D. Cornell et. al., J. Am. Chem. Soc. 117, 5179-5197 (1995); and in “CHARMM: A program for macromolecular energy, minimization, and dynamics calculations”, B. R. Brooks, et. al. J. Comp. Chem. 4, 187-217 (1983). While they have been successfully used in studying some problems of proteins and other molecules, in the foreseeable future, computational methods are not expected to have the capacity for simulation of proteins and nucleic acids for orders of magnitude longer than the microsecond range.

The estimated time scale for folding/unfolding events in proteins, ligand-receptor binding/dissociation, and interaction of nano-molecular-machine with its substrates ranges from hundreds of milliseconds to tens of seconds as described in “Kinetic analysis of the unfolding and refolding of ribonuclease T1 by a stopped-flow double-mixing technique”, L. M. Mayr et. al., Biochemistry 35, 5550-5561 (1996); and in “Studies of the binding of actinomycin and related compounds to DNA”, W. Muller, and D. M. Crothers, J. Mol. Biol. 35, 251-290 (1968). In contrast, the longest achieved simulation time is 1 microsecond for a small protein, consisting of only 36 amino acids, on a 256-node CRAY T3E supercomputer, as described in “Pathways to a protein folding intermediate observed in a 1-microsecond simulation in aqueous solution”, Y. Duan and P. A. Kollman. Science 282, 740-744 (1998). Hence there is a big gap (5 to 7 orders of magnitude) between simulation time scale and that of certain molecular events. Given that it is unlikely the computer approach in the near future is capable of conducting “long” enough time-scale molecular dynamics simulation, a new approach needs to be introduced.

### SUMMARY OF THE INVENTION

The present invention seeks to address the problems above, and in particular to provide a new approach for the simulation of biological and/or chemical reaction pathway, and for the molecular dynamic simulation of biomolecules and nano-molecular systems by comprising constructing set of binding, reaction, concentration and/or molecular dynamics equations and electronic circuits corresponding to such equations.

According to a first embodiment, the invention provides a method for simulation of at least one biological and/or chemical reaction pathway comprising:
preparing a map of at least one biological and/or chemical reaction pathway;
constructing at least one set of binding and reaction equation from the pathway map;
constructing at least one set of concentration equation for molecules of the pathway map;
constructing an electronic circuit corresponding to every set of equation;
determining simulation of pathway by measuring voltage at two or more connection points of the circuit.

In particular, the binding, reaction and/or concentration equation may be a linear or non-linear first- or second-order ordinary differential equation (ODE).

The electronic circuit may comprise at least one of the following circuit units: linear protein/molecule concentration ±kxᵢ unit; protein/molecule concentration power ±kxⱼ^{a} unit; ligand-protein concentration product ±Lxᵢ unit; ligand-protein concentration power product ±kLxᵢ^{a} unit; protein-protein concentration product ±kxᵢxⱼ unit; protein-protein concentration power product ±kxᵢ^{a}xⱼ^{b} unit; stochastic rate constant generator unit that replaces a forward/reverse binding/reaction rate constant k by a stochastic value; and
wherein, k is a forward/reverse binding/reaction rate constant, L the concentration of a ligand, xᵢ and xⱼ are the concentration of protein/molecule xᵢ and xⱼ respectively, a and b are order of power of xᵢ and x_{j.}

According to an aspect, the method of the invention further comprises maintaining the voltage level of the circuit between two fixed voltage values. For example, by: multipling scaling factors to the concentration equation; applying at least one resistor and/or amplifier at one or more connection point of the circuit, thereby scaling-down or scaling-up the voltage of one or more segment of the circuit; and/or applying automatic gain control circuits.

According to another aspect, the method of the invention further comprises adding at least one unit circuit comprising an electronic random noise generator and/or a multiplicator amplifier at one or more connection point of the circuit.

The method of the invention may further comprise determining the effect of at least one drug comprising adding at least one circuit unit associated with a receptor protein at one or more connection point of the circuit.

The method may further comprise determining deficiency, mutation and/or deletion of at least one protein of the biological pathway, comprising setting a voltage ceiling, a voltage range and/or a fixed voltage at one or more connection point of the circuit.

The invention also provides an electronic circuit system for the simulation of at least one biological and/or chemical reaction pathway, comprising at least one electronic circuit representing a set of binding, reaction and/or concentration equation. In particular, an electronic circuit system, wherein the binding, reaction and/or concentration equation is a linear or non-linear first- or second-order ordinary differential equation (ODE).

The electronic circuit may comprise at least one the following circuit units: linear protein/molecule concentration ±kxᵢ unit; protein/molecule concentration power ±kxⱼ^{a} unit; ligand-protein concentration product ±Lxᵢ unit; ligand-protein concentration power product ±kLxⱼ^{a} unit; protein-protein concentration product ±kxᵢxⱼ unit; protein-protein concentration power product ±kxᵢ^{a}xⱼ^{b} unit; stochastic rate constant generator unit that replaces a forward/reverse binding/reaction rate constant k by a stochastic value; and

wherein, k is a forward/reverse binding/reaction rate constant, L the concentration of a ligand, xᵢ and xⱼ are the concentration of protein/molecule xᵢ and xⱼ respectively, a and b are order of power of xᵢ and xⱼ respectively.

According to another embodiment, the invention provides a method for molecular dynamics simulation of biomolecules and/or nano-molecular systems comprising:
constructing at least one set of equation representing the molecular dynamics of at least one molecule of the biomolecules and/or the nano-molecular systems;
constructing an electronic circuit representing every set of equation;
determining molecular dynamics simulation by measuring voltage at two or more connection points of the circuit.

The equation may be a linear or non-linear second order ordinary differential equation (ODE).

According to an aspect, in the method of the invention, the electronic circuit comprises at least one atom-position circuit unit, wherein the atom-position circuit unit represents the position of an atom of a molecule or a molecular system.

In particular, the atom-position circuit unit comprises at least one atom-atom interaction circuit subunit, the atom-atom interaction circuit subunit representing a sub-unit of atom-atom interactions within a molecule or a molecular system and comprising internal bond stretch, angle bending, torsion, non-bonded units; and/or bond stretch, angle bending, and/or torsion units; between at least two nearest sub-units of a molecule.

Further, the atom-atom interaction circuit subunit may represent a term in the molecular dynamics equation, and wherein the atom-atom interaction circuit subunit comprises at least one of the following: bond stretch x unit, bond stretch y unit, bond stretch z unit, angle bending x type-A unit, angle bending x type-B unit, angle bending y type-A unit, angle bending y type-B unit, angle bending z type-A unit, angle bending z type-B unit, torsion x type-A unit, torsion x type-B unit, torsion y type-A unit, torsion y type-B unit, torsion z type-A unit, torsion z type-B unit, non-bonded x unit, non-bonded y unit, non-bonded z unit, hydrogen-bond x unit, hydrogen-bond y unit, and hydrogen-bond z unit; and wherein x, y, and z represent the coordinates of each atom of the molecule, and type-A represents the case of the atom being in the middle-position of an angle bending or torsion connection with other atoms, and type-B represents the case of the atom being in the end-position of an angle bending or torsion connection with other atoms.

The method may further comprise maintaining the voltage level in the circuit between two fixed voltage values. For example, by wherein x, y and z represent the coordinate of the molecule, and the voltage level of the circuit is maintained between two fixed voltage values by:
applying scaling factors to the x, y and z coordinates and to the molecular dynamic equation;
applying at least one resistor and/or amplifier at one or more connection point of the circuit, thereby scaling-down or —up the voltage of one or more segment of the circuit; and/or
applying automatic gain control circuits.

The invention also provides a circuit group representing the interaction pattern in the chemical structure of a molecule or a sub-unit of interaction pattern in the chemical structure of a molecule comprising:
a bond stretch connection between each atom pair of the molecule covalently bonded to each other;
an angle bending connection pair between a first atom and other two atoms;
a torsion connection bundle between a first atom and other three atoms; and
a non-bonded connection between each atom pair whose atoms are at least four bonds away from each other.

The electronic circuit may comprise at least one circuit unit, the circuit unit comprising at least one circuit group, the circuit group representing a sub-unit of interaction pattern in the chemical structure of a molecule and comprising internal bond stretch, angle bending, torsion, non-bonded units; and/or bond stretch, angle bending, and/or and torsion units; between at least two nearest sub-unit of a molecule.

The circuit unit may represent a term in the molecular dynamic equation, and wherein the circuit unit comprises at least one of the following: bond stretch x unit, bond stretch y unit, bond stretch z unit, angle bending x type-A unit, angle bending x type-B unit, angle bending y type-A unit, angle bending y type-B unit, angle bending z type-A unit, angle bending z type-B unit, torsion x type-A unit, torsion x type-B unit, torsion y type-A unit, torsion y type-B unit, torsion z type-A unit, torsion z type-B unit, non-bonded x unit, non-bonded y unit, non-bonded z unit, hydrogen-bond x unit, hydrogen-bond y unit, and hydrogen-bond z unit; and wherein x, y, and z represent the coordinates of each atom of the molecule, and type-A unit represents the case of the atom being in the middle-position of an angle bending or torsion connection with other atoms, and type-B represents the case of the atom being in the end-position of an angle bending or torsion connection with other atoms.

The invention further relates to a method for the manufacture of an electronic circuit representing at least one biomolecule and/or nano-molecular system, the electronic circuit comprising at least a unit circuit comprising at least a circuit group, wherein the circuit group represents a sub-unit of interaction pattern in the chemical structure of a molecule or a molecular system comprising:
introducing a bond stretch between each atom of a pair of atoms covalently bonded to each other;
introducing an angle bending connecting pair between a first atom and other two atoms;
introducing a torsion connection bundle between a first atom and other three atoms; and
introducing a non-bonded connection between each atom pair whose atoms are at least 4 bonds away from each other.

### BRIEF DESCRIPTION OF THE DRAWINGS

FIG. 1 is a flow diagram that illustrates one embodiment of a process for simulating a single or multiple biological or chemical reaction pathways by electronic circuits (100).

FIG. 2 is the map of an illustrative biological pathway, part of the caspase pathway.

FIG. 3A, 3B are the maps of the actual circuits for an illustrative biological pathway, part of the caspase pathway, wherein FIG. 3A represents the circuit for Equation I

$$( \frac{ⅆ {x}_{1}}{ⅆ t} = {k}_{1 -} {x}_{2} - {k}_{1 +} {Lx}_{1} + {ω}_{1} )$$

and FIG. 3B represents the circuit for Equation II

$$( \frac{ⅆ {x}_{2}}{ⅆ t} = {k}_{1 +} {Lx}_{1} - ( {k}_{1 -} + {k}_{2} ) {x}_{2} ) .$$

FIG. 4 is a map representing an electronic emulator for the entire pathway governed by twenty ODEs, of the caspase pathway, where blocks Equation 1 to 20 represent the circuits that emulate the twenty ODEs.

FIG. 5 is the measured voltage changes, representing variations of protein concentrations in the illustrative biological pathway, from the designed circuit for this pathway.

FIG. 6 is a schematic diagram of the construction of a section of electronic circuits representing an ODE associated with a binding/reaction event in a biological or chemical pathway. Note that switches l1 and l2 are closed at t=0 when the initial condition is x₁=α or dxᵢ/dt=β. Each switch can also be used when xᵢ or dxᵢ/dt is set at a fixed value or a fixed range.

FIG. 7 is a schematic diagram of the circuit for the first ODE of the illustrative caspase pathway. Note that switches l1 and l2 are closed at t=0 when the initial condition is x₁=α or dxᵢ/dt=β. Each switch can also be used when xᵢ or dxᵢ/dt is set at a fixed value or a fixed range.

FIG. 8 is a schematic diagram of the design plans for the special circuit units representing each term in the ODE of a binding/reaction event in a pathway.

FIG. 9 is a schematic diagram of the design plans for the special circuit units representing each term in the ODE of a binding/reaction event in a pathway. The random number ξ is in the range: 0<ξ<1.

FIG. 10 is a schematic diagram of the construction of a section of electronic circuits representing a molecular dynamics simulation ODE for the x-coordinate of an atom.

FIG. 11 is a schematic diagram of the construction of a section of electronic circuits representing a molecular dynamics simulation ODE for the y-coordinate of an atom.

FIG. 12 is a schematic diagram of the construction of a section of electronic circuits representing a molecular dynamics simulation ODE for the z-coordinate of an atom.

FIG. 13 is a schematic diagram of the bond stretch connections of the circuit group representing a subunit, amino acid, of an illustrative biomolecule, protein.

FIG. 14 is a schematic diagram of the angle bending connections of the circuit group representing a subunit, amino acid, of an illustrative biomolecule, protein.

FIG. 15 is a schematic diagram of the torsion connections of the circuit group representing a subunit, amino acid, of an illustrative biomolecule, protein.

FIG. 16 is the structure of an illustrative nano-molecular-machine, a rudimentary mimic of the enzyme ribonuclease, which has been constructed from the bucket-shaped cyclodextrin molecule (a). midazole functional groups on the rim (X in (b)) help to catalyze the region specific hydrolysis of a cyclic phosphodiester (b), which is bound in the hydrophobic cavity.

FIG. 17 is a schematic diagram of the bond stretch connections of the circuit group representing a subunit of an illustrative nano-molecular-machine, a rudimentary mimic of the enzyme ribonuclease.

FIG. 18 is a schematic diagram of the angle-bending connections of the circuit group representing a subunit of an illustrative nano-molecular-machine, a rudimentary mimic of the enzyme ribonuclease.

FIG. 19 is a schematic diagram of the torsion connections of the circuit group representing a subunit of an illustrative nano-molecular-machine, a rudimentary mimic of the enzyme ribonuclease.

FIG. 20 is a schematic diagram of the bond stretch x unit, representing the x-component of a bond stretch term.

FIG. 21 is a schematic diagram of the bond stretch y unit, representing the y-component of a bond stretch term.

FIG. 22 is a schematic diagram of the bond stretch z unit, representing the z-component of a bond stretch term.

FIG. 23 is a schematic diagram of the angle bending x type-A unit, representing the x-component of a bond angle bending term in which the atom is in the middle.

FIG. 24 is a schematic diagram of the angle bending x type-B unit, representing the x-component of a bond angle bending term in which the atom is at one end.

FIG. 25 is a schematic diagram of the angle bending y type-A unit, representing the y-component of a bond angle bending term in which the atom is in the middle.

FIG. 26 is a schematic diagram of the angle bending y type-B unit, representing the y-component of a bond angle bending term in which the atom is at one end.

FIG. 27 is a schematic diagram of the angle bending z type-A unit, representing the z-component of a bond angle bending term in which the atom is in the middle.

FIG. 28 is a schematic diagram of the angle bending z type-B unit, representing the y-component of a bond angle bending term in which the atom is at one end.

FIG. 29 is a schematic diagram of the torsion x type-A unit, representing the x-component of a bond torsion term in which the atom is in the middle.

FIG. 30 is a schematic diagram of the torsion x type-B unit, representing the x-component of a bond torsion term in which the atom is at one end.

FIG. 31 is a schematic diagram of the torsion y type-A unit, representing the y-component of a bond torsion term in which the atom is in the middle.

FIG. 32 is a schematic diagram of the torsion y type-B unit, representing the y-component of a bond torsion term in which the atom is at one end.

FIG. 33 is a schematic diagram of the torsion z type-A unit, representing the z-component of a bond torsion term in which the atom is in the middle.

FIG. 34 is a schematic diagram of the torsion z type-B unit, representing the z-component of a bond torsion term in which the atom is at one end.

FIG. 35 is a schematic diagram of the non-bonded x unit, representing the x-component of a non-bonded interaction term.

FIG. 36 is a schematic diagram of the non-bonded y unit, representing the y-component of a non-bonded interaction term.

FIG. 37 is a schematic diagram of the non-bonded z unit, representing the z-component of a non-bonded interaction term.

FIG. 38 is a schematic diagram of the H-bond x unit, representing the x-component of a hydrogen-bond term.

FIG. 39 is a schematic diagram of the H-bond y unit, representing the y-component of a hydrogen-bond term.

FIG. 40 is a schematic diagram of the H-bond z unit, representing the z-component of a hydrogen-bond term.

FIG. 41 is a schematic diagram of the rABC circuit unit and the AqA circuit unit.

FIG. 42 is a schematic diagram of the Ua circuit unit, ss circuit unit, and si circuit unit.

FIG. 43 is a schematic diagram of the pq circuit unit.

FIG. 44 is a schematic diagram of the + circuit unit and the sinθ circuit unit.

### DETAILED DESCRIPTION OF THE INVENTION

Method for Simulation of Biological and/or Chemical Reaction Pathway

According to a first embodiment, the present invention provides a method for simulation of a single or multiple biological and/or chemical reaction pathways.

It has particular application in simulation of large networks of pathways that are beyond the scope of computer methods.

It provides a potentially useful means for facilitating the study of cellular and multi-cellular processes, disease processes, effect of gene or protein mutations on biological systems, and effect of drugs on biological systems.

A single or a set of biological pathways and/or chemical reaction pathways can be represented by a map composed of a network of boxes or labels (reaction objects) connected by arrows (binding/reaction paths). This kind of representation is widely used in popular biological pathway databases such as SPAD (http://www.qrt.kyushu-u.ac.jp/spad/) and KEGG (http://www.genome.ad.jp/kegg/kegg2.html) and as described in “Mathematical modeling of epidermal growth factor receptor signaling through the phospholipase C pathway: Mechanistic insights and predictions for molecular interventions”, J. M. Haugh, A. Wells, D. A. Lauffenburger. Biotech Bioeng 70, 225-238 (2000). Each binding/reaction event in these pathways can be described by a binding/reaction equation, whose form depends on whether the event is reversible or irreversible.

The set of binding and/or reaction (binding/reaction) equations for pathways can be modeled by a set of linear and/or non-linear first-order and/or second-order ordinary differential equations. For example, non-linear first-order ordinary differential equations (ODEs) derived from the balance equation and generalized mass-action kinetics as described in “Understanding the control of metabolism” D. Fell, Portland Press, London, UK (1996) and in “The regulation of cellular systems” R. Heinrich, and S Schuster, Chapman & Hall, New York (1996). Each ODE describes the time-dependent behaviour of the concentration of a protein/molecule in the pathways. Further, equations representing the concentration of the molecules of the pathway map of the biological and/or chemical reaction pathway are also provided. The concentration equations can also be at least a set of linear and/or non-linear first-order and/or second-order ordinary differential equations. For example, non-linear first-order ordinary differential equations (ODEs).

According to this embodiment of the invention, at least one set of electronic circuits represents the at least one set of the above equations. In particular, binding, reaction and/or concentration non-linear ODEs.

Electronic circuits have been proposed to solve certain first-order and second-order nonlinear ordinary differential equation as described in “The transition from solitons to chaos in the solution of the logistic equation” M. I. Sobhy, and A. S. Burman. Int. J. Bifurcation Chaos 10, 2823-2829 (2000) as well as linear ordinary differential equation (up to second-order) as described in “The analog computer as an aid to the teaching elementary quantum mechanics”, M. K. Summers. Phys. Educ 13, 22-27 (1996).

However, electronic circuits have never been disclosed nor suggested for the purpose of simulation of biological and/or chemical reaction pathway.

Operational amplifiers, function circuits and other electronic components can be used to construct operations of differentiation, integration, sum, subtraction, multiplication, inversion, exponential, logarithm, power, and others as described in “Electronic circuits and design” D. A. Neamen. McGraw Hill (2001), “Function circuits: Design and applications” Y. J. Wong and W. E. Ott, McGraw-Hill (1976), “Modern operational circuit design” J. L. Smith, Wiley-Interseicne (1971). Hence, a set of nonlinear or linear ordinary differential equations composed of these terms can be represented by a set of electronic circuits composed of these operational amplifiers and other electronic components. The time-dependent behaviour of the concentration of a protein/molecule can be measured by the voltage at a specific point in the circuits.

Accordingly, for simulation of biological and/or chemical reaction pathways, the time-dependent behavior of the concentration of one or more reaction objects, defined as proteins/nucleic acids/ligands/substrates/reactants/products, in the pathways can be derived by measuring the voltage at specific points in the circuits.

In order to accurately describe the microscopic kinetics of binding or reaction events in pathways, all possible states for each protein or molecule need to be considered. Examples of these states include active, inactive, ligand/substrate-bound, dimmer, and any other state. The corresponding circuit section for the concentration in a particular state is typically composed of up to a few dozen operational amplifiers, a similar number of connection points (two for measuring its voltage, a few for connection to external voltage sources, and several for connection to and from other circuit units), and a number of small components such as switches etc. The circuits for a large pathway or multiple pathways may thus contain up to thousands or more such sections connected to each other and to the external voltage sources, which is feasible to construct.

Accordingly, the first embodiment provides a method for simulation of at least one biological and/or chemical reaction pathway comprising:
preparing a map of at least one biological and/or chemical reaction pathway;
constructing at least one set of binding and reaction equation from the pathway map;
constructing at least one set of concentration equation for molecules of the pathway map;
constructing an electronic circuit corresponding to every set of equation;
determining simulation of pathway by measuring voltage at two or more connection points of the circuit.

The binding, reaction and/or concentration equation may be a linear or non-linear first- or second-order ordinary differential equation (ODE). Preferably, the binding, reaction and/or concentration equation is a non-linear first-order ordinary differential equation (ODE).

In a further aspect of this invention, methods are disclosed for maintaining the voltages in the circuits (concentrations of molecules and functions of concentrations) within the allowed range. Scaling factors (which are non-zero real numbers) are applied to the concentrations and to the kinetic equations so as to keep these concentrations and each term in the equations within the allowed range. In addition, resistors and amplifiers can be used to scale-down and scale-up the voltages at certain segment of the circuits. Moreover automatic gain control circuits can also be used to ensure the voltages are within the required range. The automatic gain control circuits are described in “Function circuits: Design and applications” Y. J. Wong and W. E. Ott, McGram-Hill, 1976.

Accordingly, the invention provides a method further comprising maintaining the voltage level of the circuit between two fixed voltage values.

In particular, the voltage level of the circuit is maintained between two fixed voltage values by:
multipling scaling factors to the concentration equation;
applying at least one resistor and/or amplifier at one or more connection point of the circuit, thereby scaling-down or scaling-up the voltage of one or more segment of the circuit; and/or
applying automatic gain control circuits.

In a further aspect of this invention, stochastic effect on the binding/reaction events, which is important in cases involving low concentration or short-time event, can be taken into account by replacing the relevant binding/reaction rate constants by stochastic values (random variations around average rate constants determined by experiments or by theoretical methods). This can be accomplished in the circuits by adding at specific sites special circuit units composed of an electronic random noise generator device, such as Wayne's random noise generators, and a multiplication amplifier.

Accordingly, the method of the invention further comprises adding at least one unit circuit comprising an electronic random noise generator and/or a multiplicator amplifier at one or more connection point of the circuit.

In a further aspect of the invention, design plans for several circuit units are introduced to represent one or more, or even all possible terms in a circuit equation. Accordingly, in the method of the invention, the electronic circuit may comprise at least one of the following circuit units: linear protein/molecule concentration ±kxᵢ unit; protein/molecule concentration power ±kxᵢ^{a} unit; ligand-protein concentration product ±Lxᵢ unit; ligand-protein concentration power product ±kLxᵢ^{a} unit; protein-protein concentration product ±kxᵢxⱼ unit; protein-protein concentration power product ±kxᵢ^{a}xⱼ^{b} unit; stochastic rate constant generator unit that replaces a forward/reverse binding/reaction rate constant k by a stochastic value; and
wherein, k is a forward/reverse binding/reaction rate constant, L the concentration of a ligand, xᵢ and xⱼ are the concentration of protein/molecule xᵢ and xⱼ respectively, a and b are order of power of xᵢ and x_{j.}

By introducing additional circuit sections or by modifying the circuits, it is possible to simulate events such as the effect of drugs, protein or gene mutations, and diseases on a pathway or a group of pathways.

Therefore, in a further aspect of this invention, effect of drugs can be simulated by adding one or more circuit units (the design plan for each of these units is disclosed) at specific sites in the circuits that are associated with the respective receptor proteins. These added units represent the forward and reverse binding/reaction process between these drugs and their respective receptor proteins.

Accordingly, the method of the invention, further comprises determining the effect of at least one drug comprising adding at least one circuit unit associated with a receptor protein at one or more connection point of the circuit.

In a further aspect of this invention, deficiency or mutation of one or more proteins can be simulated by setting a voltage ceiling, or a voltage range, or a fixed voltage value at specific points in the circuits.

Accordingly, the method of the invention further comprises determining deficiency, mutation and/or deletion of at least one protein of the biological pathway, comprising setting a voltage ceiling, a voltage range and/or a fixed voltage at one or more connection point of the circuit.

The method of claim 1, wherein the biological pathway comprises at least one object, and wherein the object is protein, nucleic acid, ligand, substrate, inhibitor or antagonist, activator or agonist, reactant and/or reaction product.

According to the first embodiment of the invention, it is also provided an electronic circuit system for the simulation of at least one biological and/or chemical reaction pathway, comprising at least one electronic circuit representing a set of binding, reaction and/or concentration equation.

In the electronic circuit system, the binding, reaction and/or concentration equation may be a linear or non-linear first- or second-order ordinary differential equation (ODE). Preferably, a non-linear first-order ODE.

According to a particular aspect, the invention relates to the disclosure of design plans for the construction of circuit units that represent one or more or even all possible terms in the ODEs describing a biological or a chemical reaction pathway.

Accordingly, in the electronic circuit system of the invention, the electronic circuit may comprise at least one, or even all, the following circuit units: linear protein/molecule concentration ±kxᵢ unit; protein/molecule concentration power ±kxᵢ^{a} unit; ligand-protein concentration product ±Lxᵢ unit; ligand-protein concentration power product ±kLxᵢ^{a} unit; protein-protein concentration product ±kxᵢxⱼ unit; protein-protein concentration power product ±kxⱼ^{a}xⱼ^{b} unit; stochastic rate constant generator unit that replaces a forward/reverse binding/reaction rate constant k by a stochastic value; and
wherein, k is a forward/reverse binding/reaction rate constant, L the concentration of a ligand, xᵢ and xⱼ are the concentration of protein/molecule xᵢ and xⱼ respectively, a and b are order of power of xᵢ and xⱼ respectively.

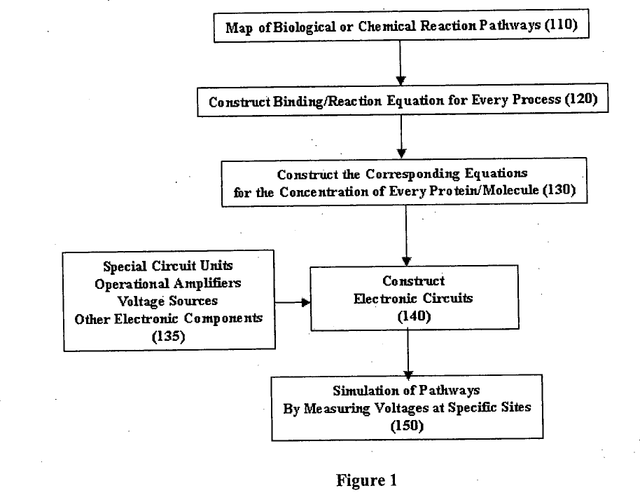

Referring now to the drawings and, in particular, to FIG. 1, there is disclosed a process 100 for carrying out a method for the simulation of a single or multiple biological or chemical reaction pathways. In the process 100, simulation of the pathways is conducted on a specifically designed set of electronic circuits by the procedure as described below and given in the flow chart of FIG. 1.

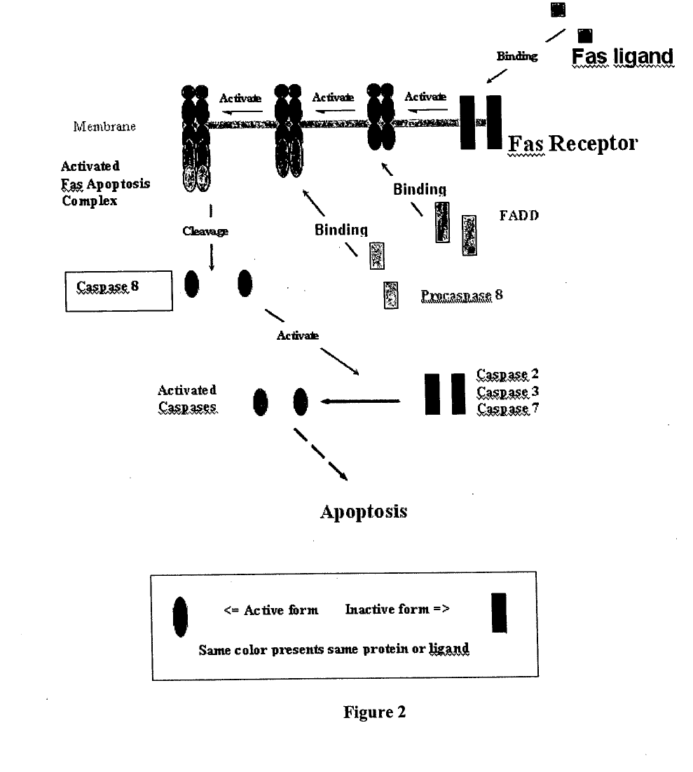

The process 100 begins at a state 110, wherein the pathways are presented as a map of a network of boxes or labels (proteins or molecules) connected by arrows (binding/reaction paths). FIG. 2 shows the map of a part of caspase pathway as an illustration.

The process 100 then moves to a sate 120 wherein the binding or reaction equation for every process in the pathway is constructed from the pathway map. Based on whether it is reversible or irreversible, the equation of an individual binding/reaction step takes the form: 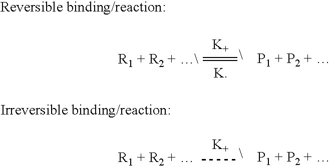
where R₁, R₂, . . . are binding/reaction objects (proteins/molecules etc) and P₁, P₂, . . . are product objects (proteins/molecules etc), K₊and K₋are forward and reverse binding/reaction rate constant respectively.

The first few reaction equations for the illustrative caspase pathway in FIG. 2 are given as: 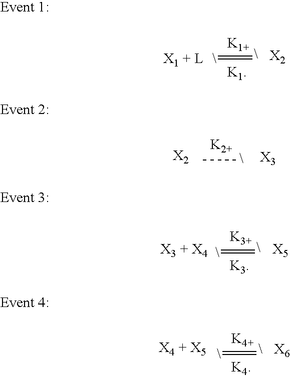
where L=Fas ligand, x₁=ligand-free Fas surface receptor, x₂=ligand-bound Fas surface receptor, x₃=clustered ligand-bound Fas surface receptor, x₄=FADD protein, x₅=complex of FADD-Fas receptor, . . . , and kᵢ₊and kᵢ are the forward and reverse reaction rate constant in the i-th path respectively. These rate constants can either be obtained from experimental data, or from theoretical computations, or estimated by empirical means based on statistical analysis of available experimental data of available of relevant reactions.

In general, the reaction equation for the i-th path is: 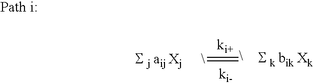
where aᵢⱼ and bᵢₖ are the stoichiometric coefficient of the j-th and k-th reaction objects respectively; j=1, . . . , Nⱼ; k=1, . . . , Nₖ; and Nⱼ and Nₖ are number of reaction objects and number of product objects respectively.

The process 100 then moves to a state 130 where in the corresponding kinetic equations for the concentration of each protein or molecule are derived from the balance equation and generalized mass-action kinetics as described in “Understanding the control of metabolism” D. Fell, Portland Press, London, UK (1996) and in “The regulation of cellular systems” R. Heinrich, and S Schuster, Chapman & Hall, New York (1996). Each equation is a non-linear first order ordinary differential equation (ODE) of the concentration of a protein/molecule in the pathways. In general, for a set of equations involving the n-th reaction object: 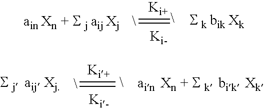
the corresponding ODE is:
dXₙ/dt=kᵢ₋Πₖ(Xₖ)^{blk}+k_{i′+}Π_{j′}(X_{j′})^{aij′}+ . . . kᵢ₊(xₙ)^{ain}Πⱼ(Xⱼ)^{aij}−k_{i′}(xₙ)^{ai′n}Πⱼk′(X_{k′})^{bi′}k′. . . +ωₙ
where xₙ is the concentration of object xₙ, ωₙ is its rate of expression/production, aᵢⱼ and bᵢⱼ are the power of the concentration in cases where the reaction rate is determined by power law representation.

The first few ODEs for the illustrative caspase pathway are:
dx₁/dt=k₁₋X₂−k₁₊L x₁+ω₁ dx₃/dt=k₂ X₂+k₃₋X₅−k₃₊x₃x₄
dx₂/dt=k₁₊L X₁−(k₁₋+k₂)x₂ dx₄/dt=k₃₋X₅+k₅X₆−k₃₊X₃X₄−k₅₊X₄ X₅+ω₄
where the ligand concentration L and rate of expression ωⁿ n of protein xₙ are assumed to be time-dependent function.

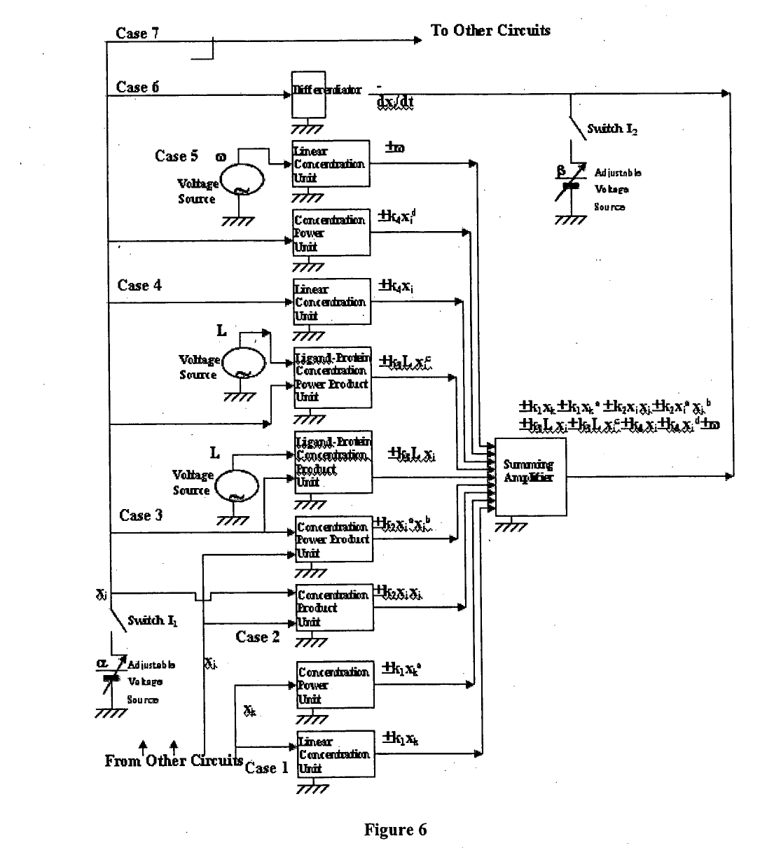

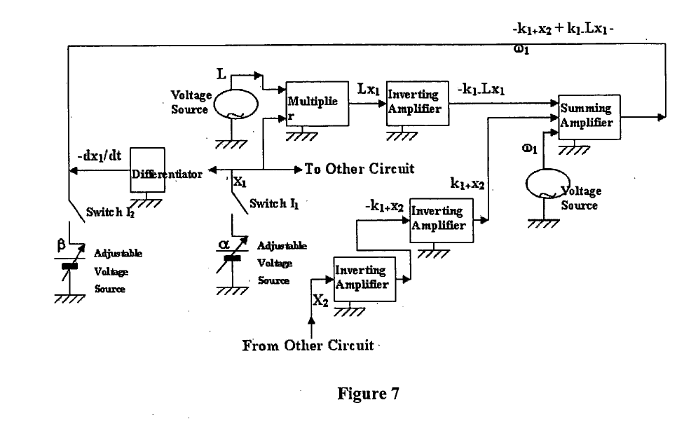

Referring back to FIG. 1, the process 100 then moves to a state 140 wherein a network of electronic circuits are constructed to represent the ODEs of a pathway or a network of pathways. This circuit network is composed of specially designed circuit units as disclosed in this patent and known components such as operational amplifiers, voltage sources representing time-dependent distribution of ligands or molecules, and other electronic circuit components such as switches and voltage sources. Each equation has a circuit, which is connected to other circuits. An equation normally contains no more than a dozen terms or variables, and thus its circuit needs to have no more than a dozen connection points to other circuits. Each circuit starts with a point xᵢ, which is connected to a switch that controls the initial condition, or the range, or the fixed value of voltage. This point is connected to other parts of the circuit by a combination of one or more of the disclosed specially designed circuit units together with a differentiator and a summing amplifier as illustrated in FIG. 6. FIG. 7 shows the actual circuit design for the first ODE of the illustrative caspase pathway. The differentiator, summing amplifier, and inverting amplifier are described in “Electronic circuit analysis and design, 2^{nd} edition” D. A. Neamen, McGraw-Hill, 2001. The multiplier is described in “Fundamentals of linear circuits” T. L. Floyd, Macmillan Publishing Co. 1992.

The process 100 then moves to a simulation state 150 wherein the time-dependent kinetics of the concentration of one or more proteins or molecules in a pathway or a group of pathways can be determined by measurement of voltages at specific sites of the circuits. For the circuit illustrated in FIG. 6, the voltage at xᵢ corresponds to the concentration of protein/molecule xᵢ. For the circuit illustrated in FIG. 7, the voltage at x₁ corresponds to the concentration of protein x₁.

Construction Plan for the Specially Designed Circuit Units Representing Different Terms in an ODE For Pathway Simulation

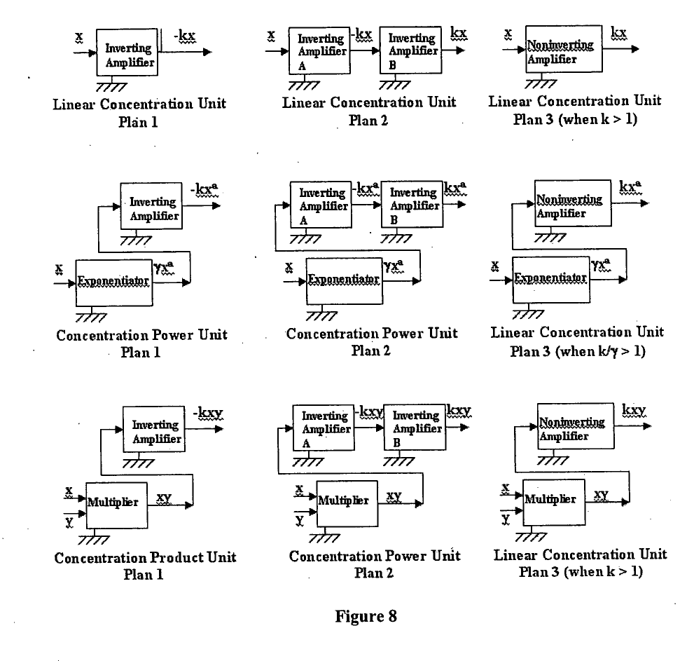

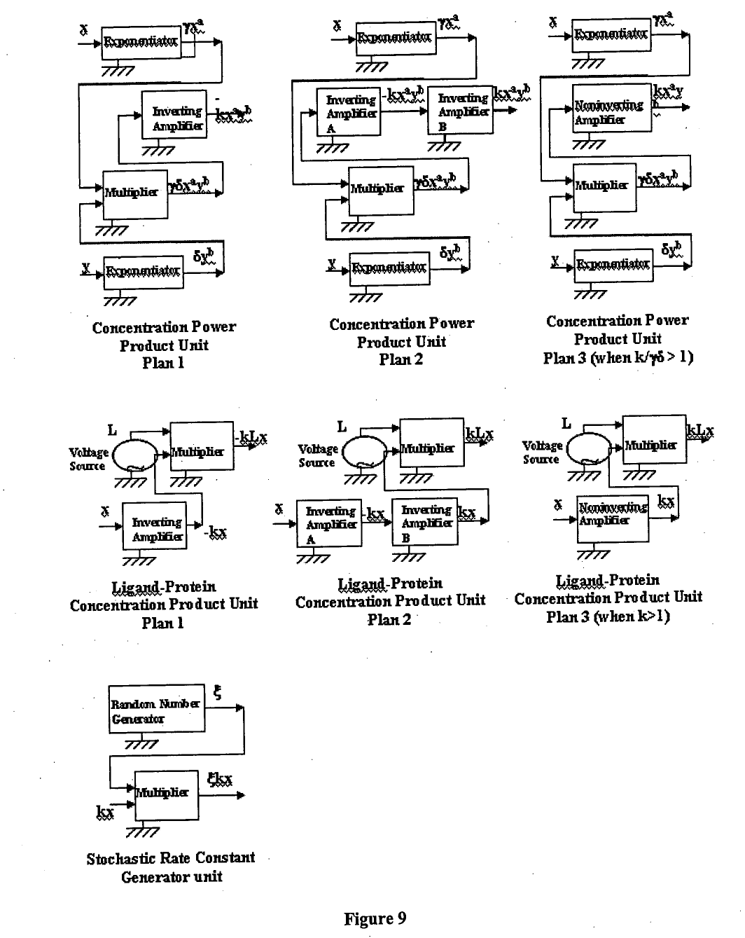

Referring now to FIG. 8 and FIG. 9, there are disclosed design plans for construction of the special circuit units according to the invention representing all possible terms of an ordinary differential equation associated with a biological and/or chemical reaction pathway. The operational amplifiers and random noise generator in these units are all described in the literature. The inverting amplifier and noninverting amplifier are described in “Electronic circuit analysis and design, 2^{nd} edition” D. A. Neamen, McGraw-Hill, 2001. The multiplier is described in “Fundamentals of linear circuits” T. L. Floyd, Macmillan Publishing Co. 1992. The exponentiator is described in “Function circuits: Design and applications” Y. J. Wong and W. E. Ott, McGram-Hill, 1976. The random noise generator is described in “A Noise-Based IC Random Number Generator for Applications in Cryptography,” Petrie, C. S. and Connelly, J. A., IEEE Transactions on Circuits and Systems, Part I, Vol. 47, May 2000, pp. 615-621.

Methods for Maintaining the Voltages in the Circuits Within Allowed Range

Normally the concentration of a molecule can be scaled into the allowed voltage range of a circuit. In case that this may not be so, or in case that the derivative of concentration exceeds the voltage range, or in case that some terms in the kinetic equation may exceed the voltage range, the following methods can be used to maintain the voltage level of the circuit between two voltage values:
(1) Applying scaling factors to the concentrations or to the pathway simulation ODEs so as to keep the concentrations and each term in the equations within the allowed range.
This can be accomplished by multiplying an appropriately selected small number δ to the pathway simulation ODEs (that is, using non-zero real numbers)
(2) Resistors are used to scale-down the voltages at the input end of a segment of the circuits and amplifiers are used at the output end of the segment to sale-up the voltages to the proper level.
This can be accomplished by applying at least one resistor and/or amplifier at one or more connection point of the circuit, thereby scaling-down or scaling-up the voltage of one or more segment of the circuit.
(3) Automatic gain control circuits can be added to the circuits to ensure the voltages are within the required range.
   Simulation of Effect of Drugs

The effect of drugs on a pathway or a group of pathways can be simulated by adding ligand-protein concentration product units to the circuit sections of the drug receptor proteins. This corresponds to case 3 in FIG. 6. The ligand-protein concentration product units are shown in FIG. 9.

Illustrative Example: Electronic Pathway Emulator of a Caspase Pathway

As mentioned before in the description of the first embodiment of the invention, a pathway can be described by a set of binding/reaction equations. This set of binding and/or reaction equations can be further modeled by a set of ODEs. An illustrative biological pathway is part of caspase pathway in FIG. 2 is governed by the following 20 simultaneous ODEs.

$$\begin{matrix}\frac{ⅆ {x}_{1}}{ⅆ t} = {k}_{1 -} {x}_{2} - {k}_{1 +} {Lx}_{1} + {ω}_{1} & ( I ) \\ \frac{ⅆ {x}_{2}}{ⅆ t} = {k}_{1 +} {Lx}_{1} - ( {k}_{1 -} + {k}_{2} ) {x}_{2} & ( II ) \\ \frac{ⅆ {x}_{3}}{ⅆ t} = {k}_{2} {x}_{2} + {k}_{3 -} {x}_{5} - {k}_{3 +} {x}_{3} {x}_{4} & ( III ) \\ \frac{ⅆ {x}_{4}}{ⅆ t} = {k}_{3 -} {x}_{5} + {k}_{5 -} {x}_{6} - {k}_{3 +} {x}_{3} {x}_{4} - {k}_{5 +} {x}_{4} {x}_{5} + {ω}_{4} & ( IV ) \\ \frac{ⅆ {x}_{5}}{ⅆ t} = {k}_{5 -} {x}_{6} + {k}_{3 +} {x}_{3} {x}_{4} - {k}_{3 -} {x}_{5} - {k}_{5 +} {x}_{4} {x}_{5} & ( V ) \\ \begin{matrix}\frac{ⅆ {x}_{6}}{ⅆ t} = {k}_{6 -} {x}_{8} + {k}_{9} {x}_{9} + {k}_{10 -} {x}_{11} + \\ {k}_{5 +} {x}_{4} {x}_{5} - {k}_{5 -} {x}_{6} - {k}_{6 +} {x}_{6} {x}_{7} - {k}_{10 +} {x}_{6} {x}_{10}\end{matrix} & ( VI ) \\ \frac{ⅆ {x}_{7}}{ⅆ t} = {k}_{6 -} {x}_{8} + {k}_{8 -} {x}_{9} - {k}_{6 +} {x}_{6} {x}_{7} - {k}_{8 +} {x}_{7} {x}_{8} + {ω}_{7} & ( VII ) \\ \begin{matrix}\frac{ⅆ {x}_{8}}{ⅆ t} = {k}_{8 +} {x}_{9} + {k}_{11 -} {x}_{12} + \\ {k}_{6 +} {x}_{6} {x}_{7} - {k}_{6 -} {x}_{8} - {k}_{8 -} {x}_{7} {x}_{8} - {k}_{11 +} {x}_{8} {x}_{10}\end{matrix} & ( VIII ) \\ \frac{ⅆ {x}_{9}}{ⅆ t} = {k}_{8 -} {x}_{7} {x}_{8} - ( {k}_{8 +} + {k}_{9} ) {x}_{9} & ( IX ) \\ \frac{ⅆ {x}_{10}}{ⅆ t} = {k}_{10 -} {x}_{11} + {k}_{11 -} {x}_{12} - {k}_{10 +} {x}_{6} {x}_{10} - {k}_{11 +} {x}_{8} {x}_{10} + {ω}_{10} & ( X ) \\ \frac{ⅆ {x}_{11}}{ⅆ t} = {k}_{10 +} {x}_{6} {x}_{10} - {k}_{10 -} {x}_{11} & ( XI ) \\ \frac{ⅆ {x}_{12}}{ⅆ t} = {k}_{11 +} {x}_{8} {x}_{10} - {k}_{11 -} {x}_{12} & ( XII ) \\ \begin{matrix}\frac{ⅆ {x}_{13}}{ⅆ t} = {k}_{9} {x}_{9} + {k}_{13 -} {x}_{15} + {k}_{15} {x}_{15} + \\ {k}_{17 -} {x}_{18} - {k}_{13 +} {x}_{13} {x}_{14} - {k}_{17 +} {x}_{13} {x}_{17}\end{matrix} & ( XIII ) \\ \frac{ⅆ {x}_{14}}{ⅆ t} = {k}_{13 -} {x}_{15} - {k}_{13 +} {x}_{13} {x}_{14} + {ω}_{14} & ( XIV ) \\ \frac{ⅆ {x}_{15}}{ⅆ t} = {k}_{13 +} {x}_{13} {x}_{14} - ( {k}_{13 -} + {k}_{15} ) {x}_{15} & ( XV ) \\ \frac{ⅆ {x}_{16}}{ⅆ t} = {k}_{15} {x}_{15} + {k}_{19 -} {x}_{20} - {k}_{19 +} {x}_{16} {x}_{19} & ( XVI ) \\ \frac{ⅆ {x}_{17}}{ⅆ t} = {k}_{17 -} {x}_{18} - {k}_{17 +} {x}_{13} {x}_{17} + {ω}_{17} & ( XVII ) \\ \frac{ⅆ {x}_{18}}{ⅆ t} = {k}_{17 +} {x}_{13} {x}_{17} - {k}_{17 -} {x}_{18} & ( XVIII ) \\ \frac{ⅆ {x}_{19}}{ⅆ t} = {k}_{19 -} {x}_{20} - {k}_{19 +} {x}_{16} {x}_{19} + {ω}_{19} & ( XIX ) \\ \frac{ⅆ {x}_{20}}{ⅆ t} = {k}_{19 +} {x}_{16} {x}_{19} - {k}_{19 -} {x}_{20} & ( XX )\end{matrix}$$

where the ligand concentration L and rate of expression Con can change with time (a time-dependent function). Variable x1 to x20 represent the protein concentration at the respective paths. This set of nonlinear ODEs can be represented by a corresponding set of electronic circuits composed of different function blocks. Thus, an electronic biological pathways emulator can be built to mimic and study the biological process.

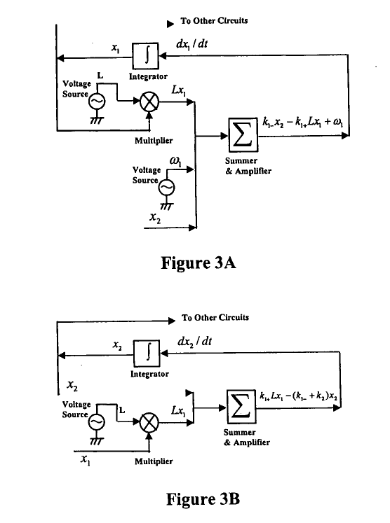

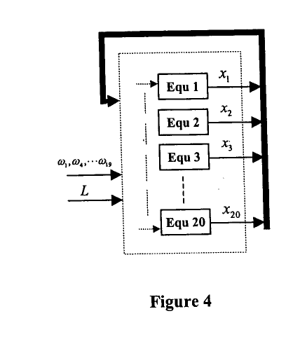

Among the given 20 simultaneous ODEs, Eqn. (I) to (IV) are of typical types. These typical equations can be emulated using the circuits shown in FIGS. 3A, 3B and in FIG. 4.

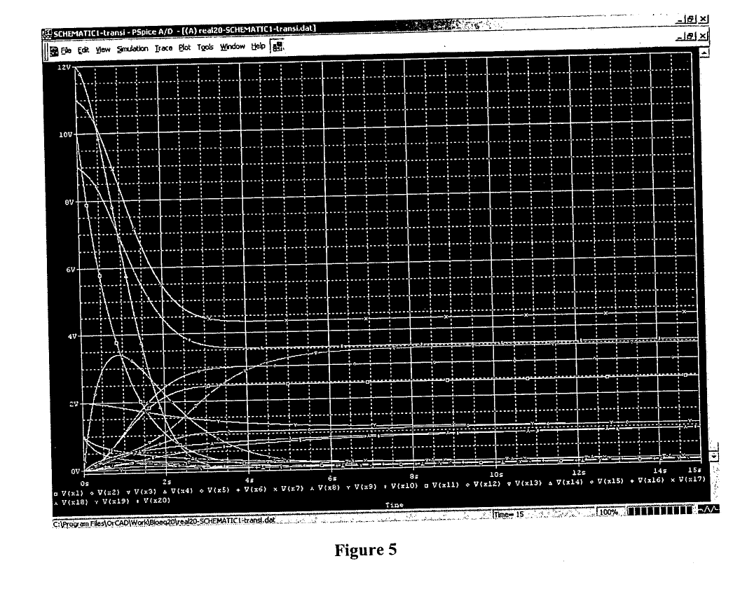

The emulator circuit has been constructed and the measured voltages, representing variations of protein concentrations in the illustrative biological pathway, are shown in FIG. 5, where voltage x1, x2, . . . x20 represent the concentration of each protein in a particular state (active or inactive). The results have shown the expected behaviour as found in computer simulation.

Molecular Dynamics Simulations of Biomolecules and/or Nano-Molecular-System

According to a second embodiment, the invention relates to molecular dynamics simulations of biomolecules and/or nano-molecular-systems.

Nano-molecular-systems refer to: nano-sized or nano-structured materials (such as molecular films, nanotubes, nanoscopic particles with specific electronic, optical or magnetic properties), nano-scale molecular mechanical or manufacturing systems (capable of guiding reactive molecules to 0.1 nm precision), other nano-scale devices (molecular motors, carriers, containers, pumps, circuits, tools etc.). These are described in “Nanosystems: molecular machinery, manufacturing, and computation” by K. Eric Drexler (Wiley 1992).

The molecular dynamics of a protein/nucleic acid/organic molecule can be represented by a set of linear and/or non-linear second-order ordinary differential equations (ODEs) derived from the Newton's second law of motion given the energy functions, force fields and a starting 3D structure of the system, as described in “A second generation force field for simulation of proteins, nucleic acids, and organic molecules”, W. D. Cornell et. al., J. Am. Chem. Soc. 117, 5179-5197 (1995); and in “CHARMM: A program for macromolecular energy, minimization, and dynamics calculations”, B. R. Brooks, et. al. J. Comp. Chem. 4, 187-217 (1983). Each ODE describes the time-dependent change of the x- or y- or z- coordinate of each atom in a studied molecule.

According to the second embodiment of the invention, a corresponding set of electronic circuits is proposed to represent this set of linear or non-linear ODEs. This set of electronic circuits is composed of operational amplifiers, function circuits and other electronic circuit elements. A combination of one or more specially designed circuit units (composed of operational amplifiers, function circuits and other electronic components together with differentiator and summing amplifier) is used to represent each term of the ODEs. The time-dependent position of each atom in a protein/nucleic acid/organic molecule can be measured by the voltage at a specific point in the circuits.

Electronic circuits have been proposed to solve certain first-order and second-order nonlinear ordinary differential equation as described in “The transition from solitons to chaos in the solution of the logistic equation” M. I. Sobhy, and A. S. Burman. Int. J. Bifurcation Chaos 10, 2823-2829 (2000) as well as linear ordinary differential equation (up to second-order) as described in “The analog computer as an aid to the teaching elementary quantum mechanics”, M. K. Summers. Phys. Educ 13, 22-27 (1996). However, electronic circuits have never been disclosed nor suggested for the purpose of molecular dynamics simulations of biomolecules and/or nano-molecular systems.

If a 3D structure is not available, a starting structure of a molecule can be generated from its molecular bond connectivity profile and from the standard average bond length, angle and torsion. Solution of these molecular dynamics simulation equations gives the time evolution of the position of each atom of a studied molecule. All the terms in this equation can be represented by a combination of existing operational amplifiers, function circuits and other electronic components. Hence it is feasible to use electronic circuits to solve these equations and thus conduct molecular dynamics simulations.

A protein normally consists of thousands of atoms. Each atom has three equations describing its x-, y-, or z- coordinate respectively. The corresponding circuit section for each coordinate is typically composed of up to a few dozen bond-stretch/angle/torsion units plus up to thousands of non-bonded units. If a force field with separate hydrogen bond terms is used, then this circuit section also contains a few additional units for hydrogen bonds. If explicit solvent is used, then this circuit section also contains additional non-bonded units related to the non-bonded interactions with water molecules. Each unit consists of approximately a few dozen operational amplifiers and function amplifiers, a similar number of connection points (two for measuring its voltage, a few for connection to external voltage sources, and the rest for connection to and from other circuit units), and a number of small components such as switches etc. The circuits for a typical protein may thus contain up to thousands or more such sections connected to each other and to the external voltage sources, which is feasible to construct.

Operational amplifiers, function circuits and other electronic components can be used to construct operations of differentiation, integration, sum, subtraction, multiplication, inversion, exponential, logarithm, power, and others as described in “Electronic circuits and design” D. A. Neamen. McGraw Hill (2001), “Function circuits: Design and applications” Y. J. Wong and W. E. Ott, McGraw-Hill (1976), “Modern operational circuit design” J. L. Smith, Wiley-Interseicne (1971). Hence, a set of nonlinear or linear ordinary differential equations composed of these terms can be represented by a set of electronic circuits composed of these operational amplifiers and other electronic components. The time-dependent behavior of the concentration of a protein/molecule can be measured by the voltage at a specific point in the circuits.

The present invention provides a method for molecular dynamics simulation of biomolecules and/or nano-molecular systems comprising:
constructing at least one set of equation representing the molecular dynamics of at least one molecule of the biomolecules and/or the nano-molecular systems;
constructing an electronic circuit representing every set of equation; and
determining molecular dynamics simulation by measuring voltage at two or more connection points of the circuit.

The equations may be linear and/or non-linear second order ordinary differential equations (ODEs). Preferably, non-linear second order ordinary differential equations (ODEs).

The biomolecule and/or nano-molecular system of the invention comprise in general, but not exclusively, amino acids, nucleotides, organic molecules, and/or inorganic molecules.

According to one aspect of the invention, construction plan is disclosed for circuit group of each unit in a biomolecule (amino acid or nucleotide) or a nano-molecular-system to represent all its internal interaction bonded and non-bonded interactions and bonded interactions to its nearest neighbouring amino acid or nucleotide. Each circuit group is composed of at least one of: (1) internal bond stretch, angle bending, torsion, non-bonded units; and (2) bond stretch, angle bending, and torsion units to its two nearest neighbouring amino acid or nucleotide. In a molecular dynamics simulation of a protein or nucleic acid, these circuit groups can be combined together according to the sequence of the protein or nucleic acid. Additional non-bonded units representing inter-residue non-bonded interactions can be added to each circuit group accordingly.

Accordingly, the electronic circuit of the invention may comprise at least one atom-position circuit unit, wherein the atom-position circuit unit represents the position of an atom of a molecule or a molecular system. The atom-position circuit unit comprises at least one atom-atom interaction circuit subunit, the atom-atom interaction circuit subunit representing a sub-unit of atom-atom interactions within a molecule or a molecular system and comprising at least one of: internal bond stretch, angle bending, torsion, non-bonded units; bond stretch, angle bending, and torsion units; between at least two nearest sub-unit of a molecule.

Each atom-atom interaction circuit subunit represents a term in the molecular dynamics equation and comprises at least one of the following: bond stretch x unit, bond stretch y unit, bond stretch z unit, angle bending x type-A unit, angle bending x type-B unit, angle bending y type-A unit, angle bending y type-B unit, angle bending z type-A unit, angle bending z type-B unit, torsion x type-A unit, torsion x type-B unit, torsion y type-A unit, torsion y type-B unit, torsion z type-A unit, torsion z type-B unit, non-bonded x unit, non-bonded y unit, non-bonded z unit, hydrogen-bond x unit, hydrogen-bond y unit, and hydrogen-bond z unit; and
wherein x, y, and z represent the coordinates of each atom of the molecule, and type-A represents the case of the atom being in the middle-position of an angle bending or torsion connection with other atoms, and type-B represents the case of the atom being in the end-position of an angle bending or torsion connection with other atoms.

According to a particular aspect, all the twenty subunit elements listed above may be used for the construction of the circuit units and electronic circuits of the invention.

In a further aspect of this invention, methods are disclosed for maintaining the voltages in the circuits (xyz coordinates and functions of xyz coordinates) within the allowed range. Scaling factors are applied to x, y, z coordinates and to the molecular dynamics equations so as to keep the x, y, z coordinates and each term in the equations within the allowed range. In addition, resistors and amplifiers can be used to scale-down and scale-up the voltages at certain segment of the circuits. Moreover automatic gain control circuits can also be used to ensure the voltages are within the required range. The automatic gain control circuits are described in “Function circuits: Design and applications” Y. J. Wong and W. E. Ott, McGram-Hill, 1976.

Accordingly, the method further comprises maintaining the voltage level in the circuit between two fixed voltage values. In particular, x, y and z represent the coordinates of the molecule, and the voltage level of the circuit is maintained between two fixed voltage values by:
applying (non-zero real numbers) scaling factors to the x, y and z coordinates and to the molecular dynamic equation;
applying at least one resistor and/or amplifier at one or more connection point of the circuit, thereby scaling-down or —up the voltage of one or more segment of the circuit; and/or
applying automatic gain control circuits.

According to another aspect of the second embodiment, it is provided a circuit group representing the interaction pattern in the chemical structure of a molecule or a sub-unit of interaction pattern in the chemical structure of a molecule comprising at least one of the following:
a bond stretch connection between each atom pair of the molecule covalently bonded to each other;
an angle bending connection pair between a first atom and other two atoms;
a torsion connection bundle between a first atom and other three atoms; and
a non-bonded connection between each atom pair whose atoms are at least four bonds away from each other.

A circuit unit according to the invention may comprise at least one circuit group as disclosed.

The invention also provides an electronic circuit comprising at least one circuit unit, the circuit unit comprising at least one circuit group, the circuit group representing a sub-unit of interaction pattern in the chemical structure of a molecule and comprising internal bond stretch, angle bending, torsion, non-bonded units; and/or bond stretch, angle bending, and/or and torsion units; between at least two nearest sub-unit of a molecule.

The electronic circuit represents a term in the molecular dynamic equation, and wherein the circuit unit comprises at least one of the following: bond stretch x unit, bond stretch y unit, bond stretch z unit, angle bending x type-A unit, angle bending x type-B unit, angle bending y type-A unit, angle bending y type-B unit, angle bending z type-A unit, angle bending z type-B unit, torsion x type-A unit, torsion x type-B unit, torsion y type-A unit, torsion y type-B unit, torsion z type-A unit, torsion z type-B unit, non-bonded x unit, non-bonded y unit, non-bonded z unit, hydrogen-bond x unit, hydrogen-bond y unit, and hydrogen-bond z unit; and wherein x, y, and z represent the coordinates of each atom of the molecule, and type-A unit represents the case of the atom being in the middle-position of an angle bending or torsion connection with other atoms, and type-B represents the case of the atom being in the end-position of an angle bending or torsion connection with other atoms.

According to a particular aspect, the invention relates to design plans for the construction of circuit units representing all possible terms in the ODEs for molecular simulation of proteins, nucleic acids and organic molecules. The units are those represented above.

The invention also provides a method for the manufacture of an electronic circuit representing at least one biomolecule and/or nano-molecular system, the electronic circuit comprising at least a unit circuit comprising at least a circuit group, wherein the circuit group represents a sub-unit of interaction pattern in the chemical structure of a molecule or a molecular system comprising:
introducing a bond stretch between each atom of a pair of atoms covalently bonded to each other;
introducing an angle bending connecting pair between a first atom and other two atoms;
introducing a torsion connection bundle between a first atom and other three atoms; and
introducing a non-bonded connection between each atom pair whose atoms are at least four bonds away from each other.

The equations of motion of molecular dynamics simulation of a molecule can be derived from Newton's second law of motion given the potential energy functions, force fields and a starting 3D structure. The potential energy functional for proteins, nucleic acids and organic molecules is given by:
V=½Σ_{bonds}Kᵣ(R−R_{eq})²+½Σ_{angles}K_{θ}(θ−θ_{eq})²⁺½ΣₜₒᵣₛᵢₒₙₛVₙ[1+cos(n−γ)]+
Σ_{non bonded}[Aᵢⱼ/rᵢⱼ¹²−Bᵢⱼ/rᵢⱼ⁶+qᵢqⱼ/εᵣrᵢⱼ]+Σ_{H bonds}V_{H}(r) (1)
as described in “A second generation force field for simulation of proteins, nucleic acids, and organic molecules”, W. D. Cornell et. al., J. Am. Chem. Soc. 117, 5179-5197 (1995); and in “CHARMM: A program for macromolecular energy, minimization, and dynamics calculations”, B. R. Brooks, et. al. J. Comp. Chem. 4, 187-217 (1983).

The hydrogen bond potential V_{H}(r) is different for different force fields. The following is a list of some of the V_{H}(r) appeared in the literatures:

$$\begin{matrix}{V}_{H} ( r ) = A / {r}^{12} - B / {r}^{6} + {q}_{i} {q}_{j} / {ɛ}_{r} {r}_{ij} & for AMBER ( same as non \text{-} bonded term ) \\ = ( A / {r}^{12} - B / {r}^{10} ) {cos}^{m} ( {θ}_{A - H - D} ) {cos}^{n} ( {θ}_{AA - A - H} ) {sw}_{1} ( r ) {sw}_{2} ( θ ) & for CHARM \\ = {{V}_{0} ( 1 - {ⅇ}^{- a ( r - r 0 )} )}^{2} - {V}_{0} & for Prohofsky \text{/} Chen\end{matrix} \qquad ( 2 )$$

All force field parameters for each atom or atom-atom pair in a biomolecule or nano-molecular-machine are given in the literature. For example, AMBER force fields are described in “A second generation force field for simulation of proteins, nucleic acids, and organic molecules”, W. D. Cornell et. al., J. Am.

Chem. Soc. 117, 5179-5197 (1995). As for organic molecules, all parameters other than partial charges are available. Partial charges of an organic molecule can be computed from quantum chemistry software such as Gaussian.

From Newton's second law, the atomic position of the i-th atom, in terms of its xyz coordinates (xᵢ, yᵢ, zᵢ) is given by:

$$\begin{matrix}\begin{matrix}{m}_{i} {ⅆ}^{2} {x}_{i} / ⅆ {t}^{2} = - ⅆ V / ⅆ {x}_{i} \\ = - {\sum }_{bonds} {K}_{r} ( R - {R}_{eq} ) {B}_{xi}^{r} - {\sum }_{angles} {K}_{θ} ( θ - {θ}_{eq} ) {B}_{xi}^{θ} + \\ {\sum }_{torsions} {nV}_{n} sin ( n ϕ - γ ) {B}_{xi}^{ϕ} - \\ {\sum }_{non bonded} [ 6 {B}_{ij} / {r}_{ij}^{7} - 12 {A}_{ij} / {r}_{ij}^{13} - {q}_{i} {q}_{j} / {ɛ}_{r} {r}_{ij} ] \\ ( {x}_{i} - {x}_{j} ) / {r}_{ij} - {\sum }_{H bonds} [ ⅆ {V}_{H} ( r ) / ⅆ r ] ( {x}_{i} - {x}_{h} ) / r\end{matrix} & ( 3 ) \\ \begin{matrix}{m}_{i} {ⅆ}^{2} {y}_{i} / ⅆ {t}^{2} = - ⅆ V / ⅆ {y}_{i} \\ = - {\sum }_{bonds} {K}_{r} ( R - {R}_{eq} ) {B}_{yi}^{r} - {\sum }_{angles} {K}_{θ} ( θ - {θ}_{eq} ) {B}_{yi}^{θ} + \\ {\sum }_{torsions} {nV}_{n} sin ( n ϕ - γ ) {B}_{yi}^{ϕ} - \\ {\sum }_{non bonded} [ 6 {B}_{ij} / {r}_{ij}^{7} - 12 {A}_{ij} / {r}_{ij}^{13} - {q}_{i} {q}_{j} / {ɛ}_{r} {r}_{ij} ] \\ ( {y}_{i} - {y}_{j} ) / {r}_{ij} - {\sum }_{H bonds} [ ⅆ {V}_{H} ( r ) / ⅆ r ] ( {y}_{i} - {y}_{h} ) / r\end{matrix} & ( 4 ) \\ \begin{matrix}{m}_{i} {ⅆ}^{2} {z}_{i} / ⅆ {t}^{2} = - ⅆ V / ⅆ {z}_{i} \\ = - {\sum }_{bonds} {K}_{r} ( R - {R}_{eq} ) {B}_{zi}^{r} - {\sum }_{angles} {K}_{θ} ( θ - {θ}_{eq} ) {B}_{zi}^{θ} + / \\ {\sum }_{torsions} {nV}_{n} sin ( n ϕ - γ ) {B}_{zi}^{ϕ} - \\ {\sum }_{non bonded} [ 6 {B}_{ij} / {r}_{ij}^{7} - 12 {A}_{ij} / {r}_{ij}^{13} - {q}_{i} {q}_{j} / {ɛ}_{r} {r}_{ij} ] \\ ( {z}_{i} - {z}_{j} ) / {r}_{ij} - {\sum }_{H bonds} [ ⅆ {V}_{H} ( r ) / ⅆ r ] ( {z}_{i} - {z}_{h} ) / r\end{matrix} & ( 5 )\end{matrix}$$

where mᵢ is the mass of the i-th atom; B^{r}ₓᵢ, B^{r}_{yi}, B^{r}_{Zi} are the x, y z components of the B-matrix for bond stretching; B^{θ}ₓᵢ, B^{θ}_{yi}, B^{θ}_{zi} are the x, y, z components for the B-matrix for bond angle bending; B^{φ}ₓᵢ, B^{φ}_{yi}, B^{φ}_{zi} are the x, y, z components for the B-matrix for torsion. As described in “Vibrational states”, S. Califano. John Wiley & Sons, New York (1976), these B-matrix elements are given by:

$$\begin{matrix}{B}_{xi}^{r} = - {A}_{ij} & ( 6 ) \\ {B}_{yi}^{r} = - {B}_{ij} & ( 7 ) \\ {B}_{zi}^{r} = - {C}_{ij} & ( 8 ) \\ \begin{matrix}{B}_{xi}^{θ} = Ea = - ( Eb + Ec ) & if I \text{-} th atom is in the middle \\ = Eb & if I \text{-} th atom is at the end\end{matrix} & ( 9 ) \\ \begin{matrix}{B}_{yi}^{θ} = Fa = - ( Fb + Fc ) & if I \text{-} th atom is in the middle \\ = Fb & if I \text{-} th atom is at the end\end{matrix} & ( 10 ) \\ \begin{matrix}{B}_{zi}^{θ} = Ga = - ( Gb + Gc ) & if I \text{-} th atom is in the middle \\ = Gb & if I \text{-} th atom is at the end\end{matrix} & ( 11 ) \\ \begin{matrix}{B}_{xi}^{ϕ} = Ua = 1 / {r}_{ij} {p}_{a}^{2} + {q}_{c} {s}_{5} / {r}_{ik} {p}_{c}^{2} - {q}_{a} {s}_{6} / {r}_{ik} {p}_{a}^{2} & if I \text{-} th atom is in the middle \\ = Ub = - {s}_{6} / {r}_{ij} {p}_{a}^{2} & if I \text{-} th atom is at the end\end{matrix} & ( 12 ) \\ \begin{matrix}{B}_{yi}^{ϕ} = Va = 1 / {r}_{ij} {p}_{a}^{2} + {q}_{c} {s}_{3} / {r}_{ik} {p}_{c}^{2} - {q}_{a} {s}_{4} / {r}_{ik} {p}_{a}^{2} & if I \text{-} th atom is in the middle \\ = Vb = - {s}_{4} / {r}_{ij} {p}_{a}^{2} & if I \text{-} th atom is at the end\end{matrix} & ( 13 ) \\ \begin{matrix}{B}_{xi}^{ϕ} = Wa = 1 / {r}_{ij} {p}_{a}^{2} + {q}_{c} {s}_{1} / {r}_{ik} {p}_{c}^{2} - {q}_{a} {s}_{2} / {r}_{ik} {p}_{a}^{2} & if I \text{-} th atom is in the middle \\ = Wb = - {s}_{2} / {r}_{ij} {p}_{a}^{2} & if I \text{-} th atom is at the end\end{matrix} & ( 14 )\end{matrix}$$

where rᵢⱼ, Aᵢⱼ, Bᵢⱼ, Cᵢⱼ, qₐ, q_{c}, pₐ, p_{c}, Eb, Ec, Fb, Fc, Gb, Gc, s₁, S₂, S₃, S₄, S₅, S₆ are given by:
rᵢⱼ=[(X₁−xⱼ)²+(yᵢ−yⱼ)²+(zᵢ−zⱼ)²])^{1/2} (15)
Aᵢⱼ=(xⱼ−xᵢ)/rᵢⱼ (16)
Bᵢⱼ=(yⱼ−yᵢ)/rᵢⱼ (17)
Cᵢⱼ=(zⱼ−zᵢ)/rᵢⱼ (18)
qₐ=cOsθₐ=AᵢⱼAᵢₖ+BᵢⱼBᵢₖ+CᵢⱼCᵢₖ (19)
q_{C}=cos θ_{c}=−(AᵢₖAₖₗ+BᵢₖBₖₗ+CᵢₖCₖₗ) (20)
pₐ=sinθₐ=(1−qₐ)^{1/2} (21)
p_{c}=sinθ_{c}=(1−q_{c})^{1/2} (22)
Eb=(Aᵢⱼqₐ−Aᵢₖ)/rᵢⱼpₐ (23)
Ec=(Aᵢₖqₐ−Aᵢⱼ)/rᵢₖpₐ (24)
Fb=(Bᵢⱼqₐ−Bᵢₖ)/rᵢⱼpₐ (25)
Fc=(Bᵢₖqₐ−Bᵢⱼ)/rᵢₖPₐ (26)
Gb=(Cᵢⱼqₐ−Cᵢₖ)/rᵢⱼpₐ (27)
Gc=(Cᵢₖqₐ−Cᵢⱼ)/rᵢₖPₐ (28)
S₁=AᵢₖBₖₗ−BᵢₖAₖₗ (29)
S₂=AᵢₖBᵢⱼ−BᵢₖAᵢⱼ (30)
S₃=AₖₗCᵢₖ−CₖₗAᵢₖ (31)
S₄=AᵢⱼCᵢₖ−CᵢⱼAᵢₖ (32)
S₅=BᵢₖCₖₗ−CᵢₖBᵢₖ (33)
S₆=BᵢₖCᵢⱼ−CᵢⱼBᵢₖ (34)
This set of nonlinear ODEs contain terms of rᵢⱼ, (xᵢ-xⱼ)×(xₖ−xⱼ), (xᵢ−xⱼ)/rᵢⱼ sin(nφ−γ) etc., which can be represented by a corresponding set of electronic analog circuits composed of known operational amplifiers, function circuits and other circuit components.

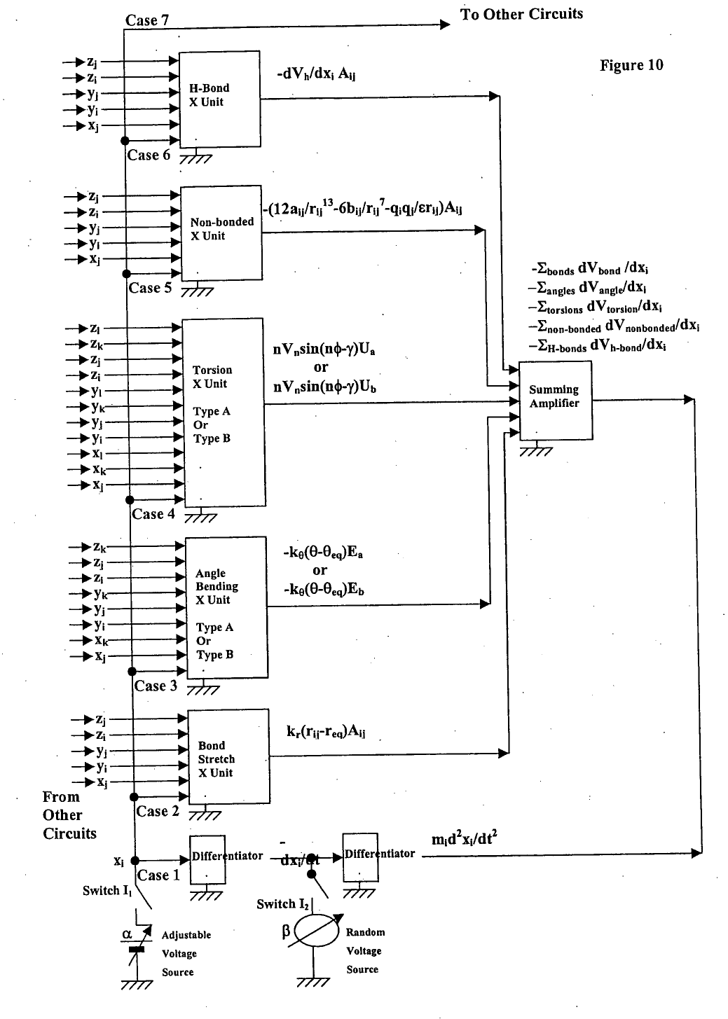

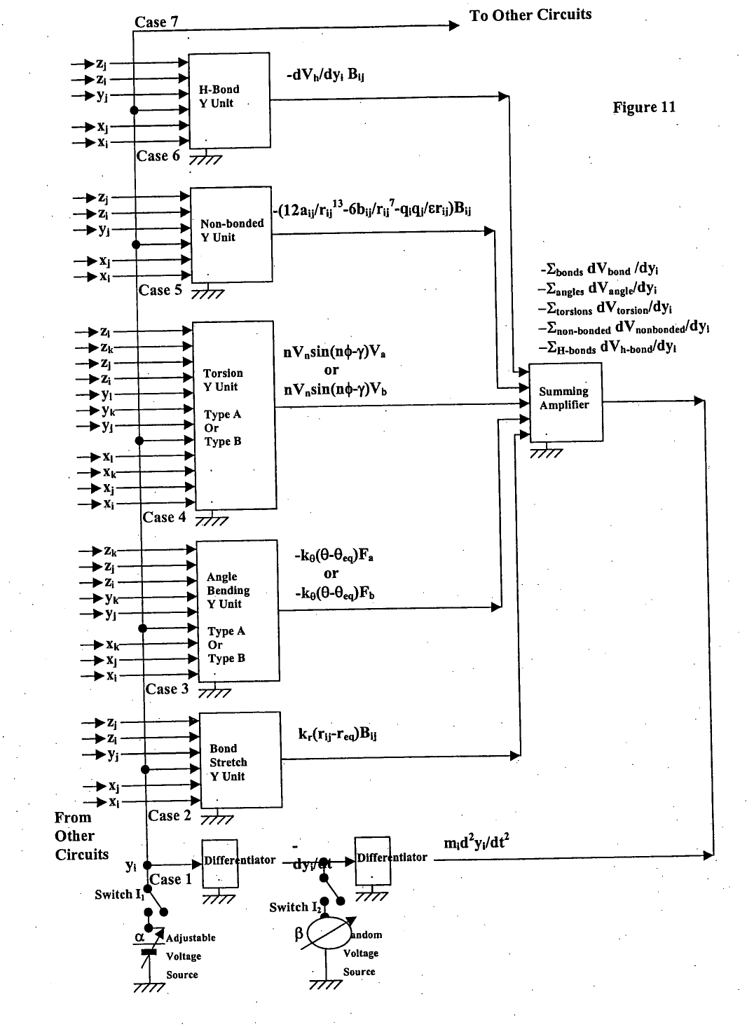

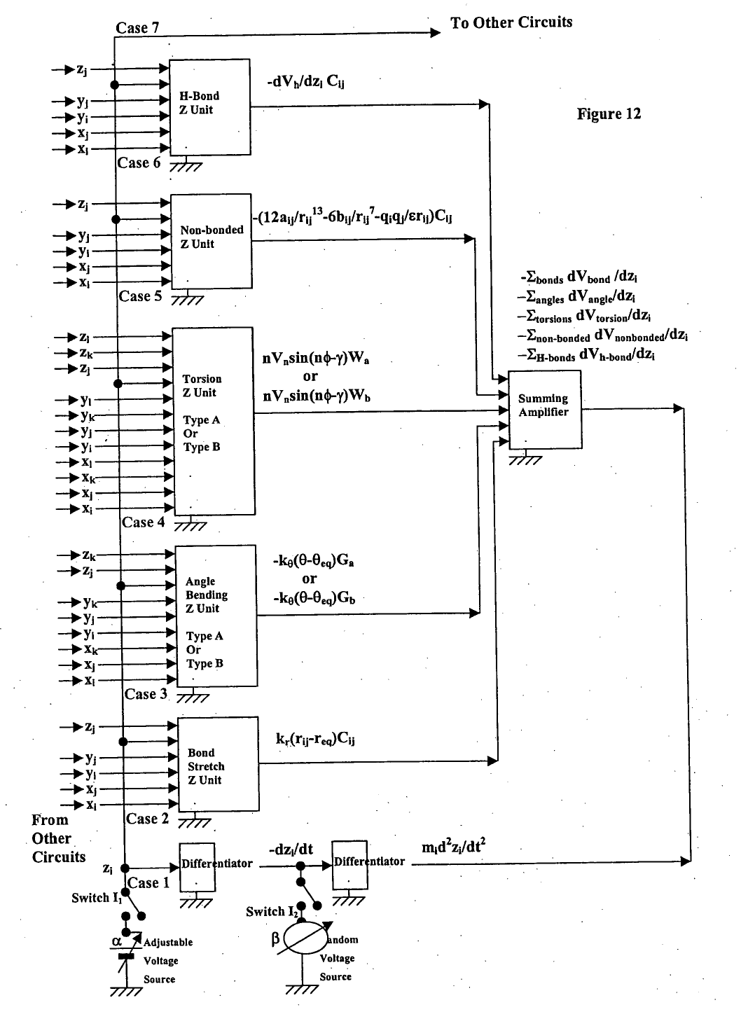

Referring now to FIG. 10, FIG. 11, and FIG. 12, there are disclosed design plans for construction of electronic circuits representing molecular dynamics simulation equations (3), (4) and (5) for each atom in a protein, nucleic acid, or organic molecule respectively. For each equation, its circuit starts with a point xᵢ or yᵢ or zᵢ, which is connected to a switch directed to a voltage source representing the initial coordinate. This point is also connected to other parts of the circuit or other circuits in a combination of one or more of the seven cases as illustrated in FIG. 10, FIG. 11, and FIG. 12. In a simulation, the time-dependent x or y or z coordinate of the i-th atom can be by measurement of voltages at xᵢ or yᵢ or zᵢ.

Construction Plan for the Specially Designed Circuit Groups Representing all the Internal Terms and Bonded terms with nearest neighbors in the ODEs of a sub-unit of a biomolecule or in a nano-molecular-machine

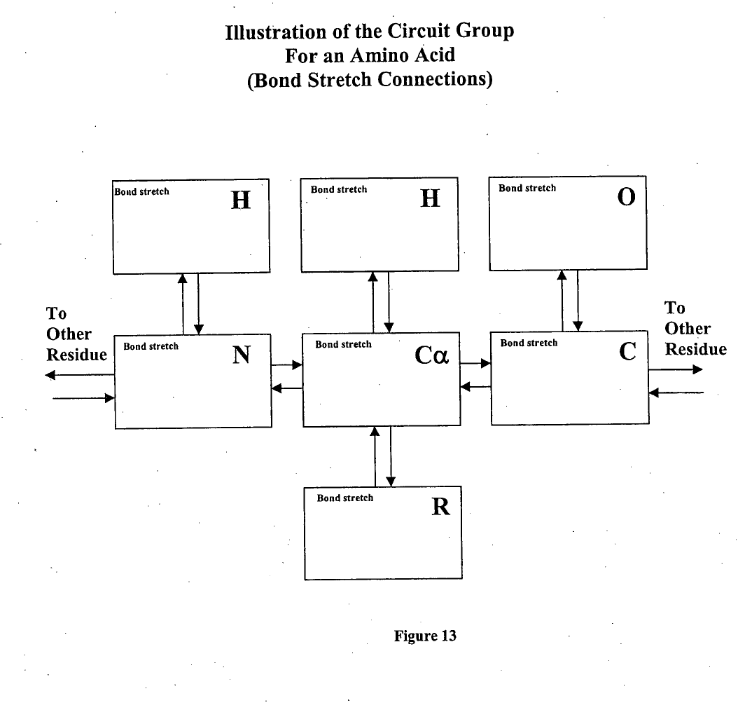

Referring now to FIG. 13 to FIG. 15, there are disclosed design plans for construction of circuit group for each illustrative sub-unit, amino acid, of a biomolecule, protein, to represent all its internal terms and bonded terms to its nearest neighboring subunits, amino acids.

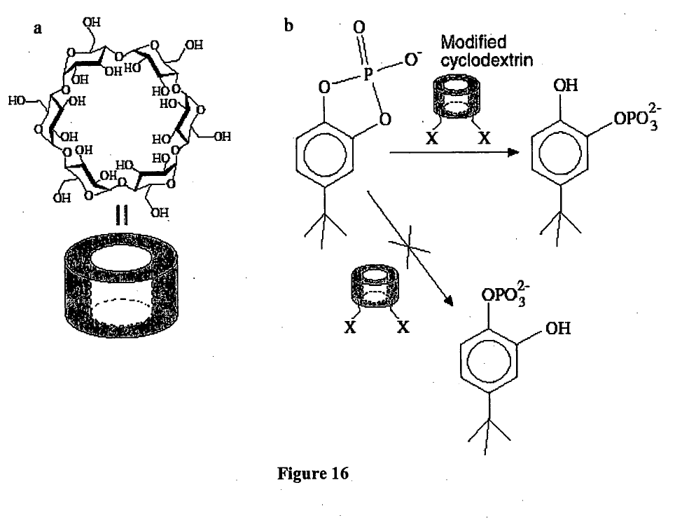

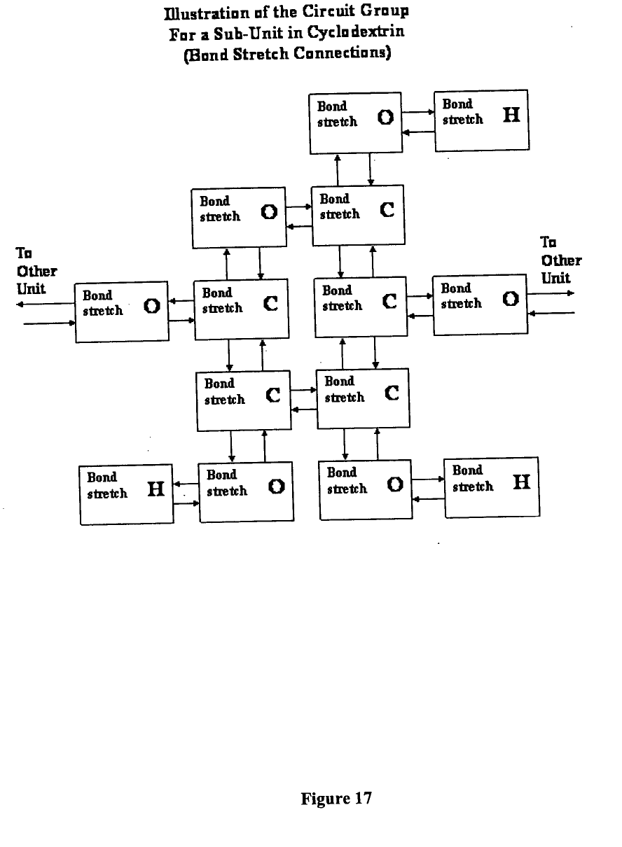

Referring now to FIG. 17 to FIG. 19, there are disclosed design plans for construction of circuit group for each sub-unit of an illustrative sub-unit of a nano-molecular-machine in FIG. 16 to represent all its internal terms and bonded terms to its nearest neighboring subunits.

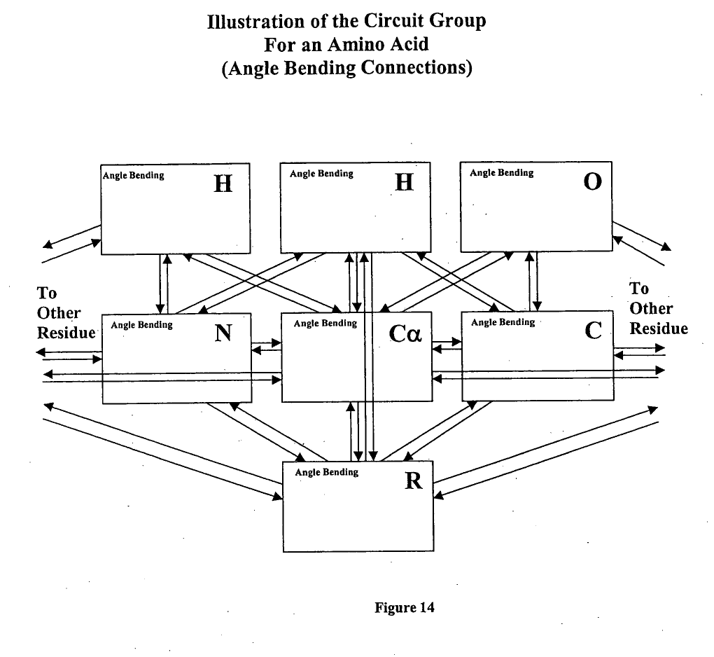

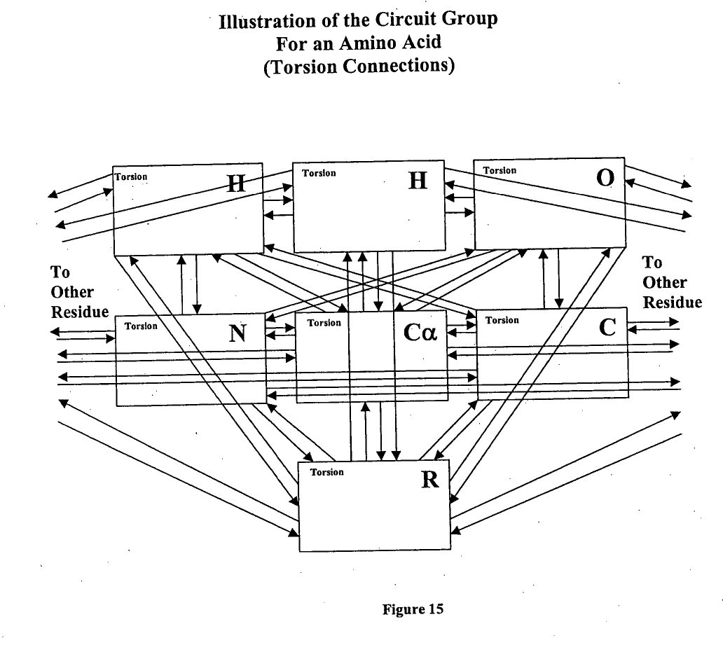

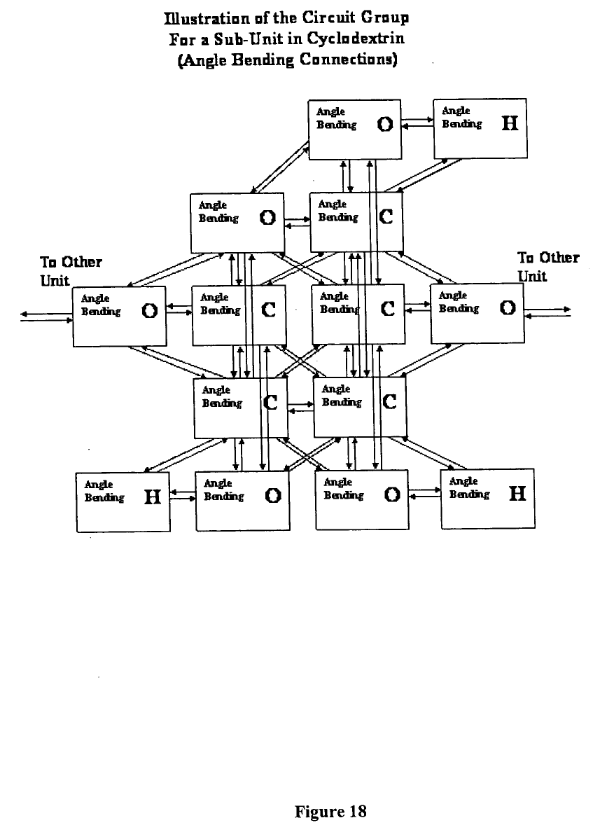

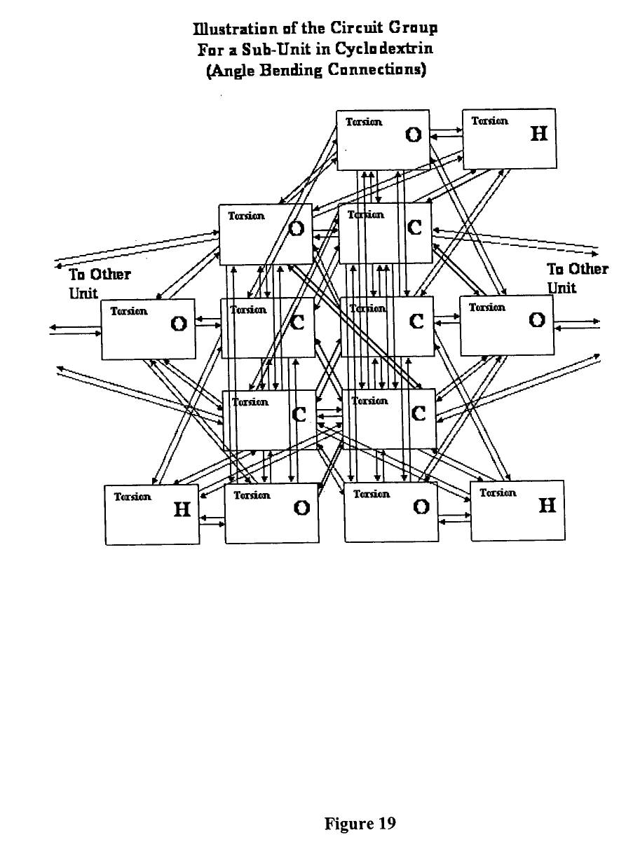

In these figures, each box represents the x, y and z circuit sections of each atom of an amino acid or nucleotide. An arrow represents a connection between two atoms such that the output voltage xⱼ, yⱼ, or Zⱼ from the x, y or z circuit section of an atom is directed to a bond-stretch, angle bending or torsion unit in the corresponding section of the atom to which the arrow is pointed. For clarity purpose, the connection profile for bond stretch, angle bending, and torsion is displayed in separate Figures. In reality, these should be put together in the same circuit group configuration. FIG. 13 and FIG. 17 illustrates connections to bond stretch units of each circuit section, FIG. 14 and FIG. 18 illustrates connections to angle bending units of each circuit section, and FIG. 15 and FIG. 19 illustrates connections to torsion units of each circuit section.

A circuit group is in general constructed by the following rules:

From the chemical structure of an amino acid or nucleotide:
A bond stretch connection is introduced to each atom pair covalently bonded to each other;
An angle bending connection pair are established from atom A to two other atoms B and C, in cases that they are linearly bonded as A-B-C or B-A-C or B-C-A etc.;
A torsion connection bundle are constructed from atom A to three other atoms B, C and D, in cases that they are linearly bonded as A-B-C-D or B-A-C-D or B-C-A-D etc.;
A non-bonded connection is introduced to each atom pair whose atoms are at least 4 bonds away from each other.
   Construction Plan for the Specially Designed Circuit Units Representing Different Terms in an ODE For Molecular Dynamics Simulation

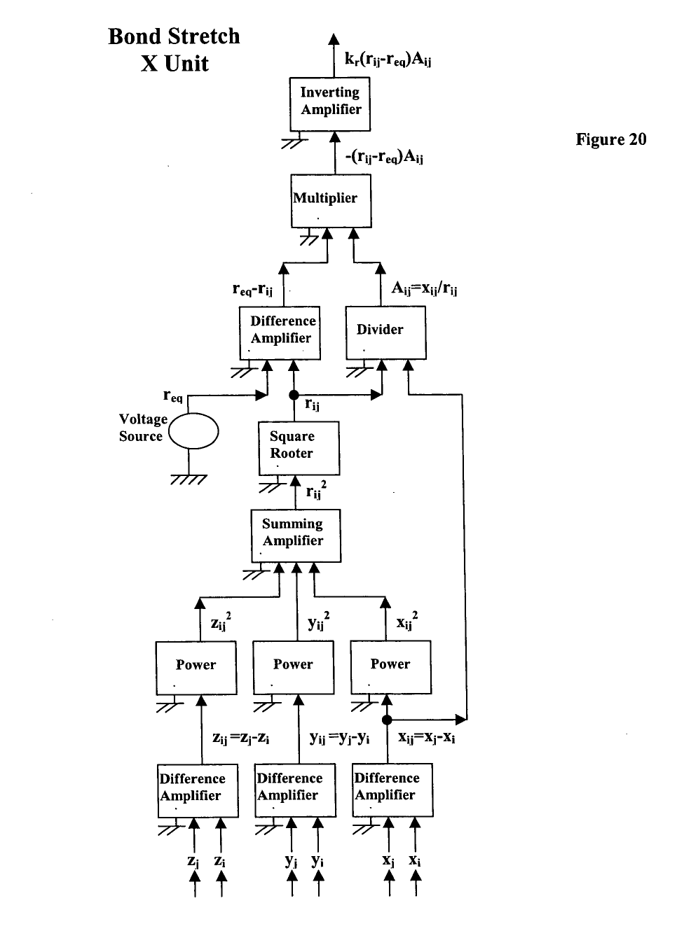

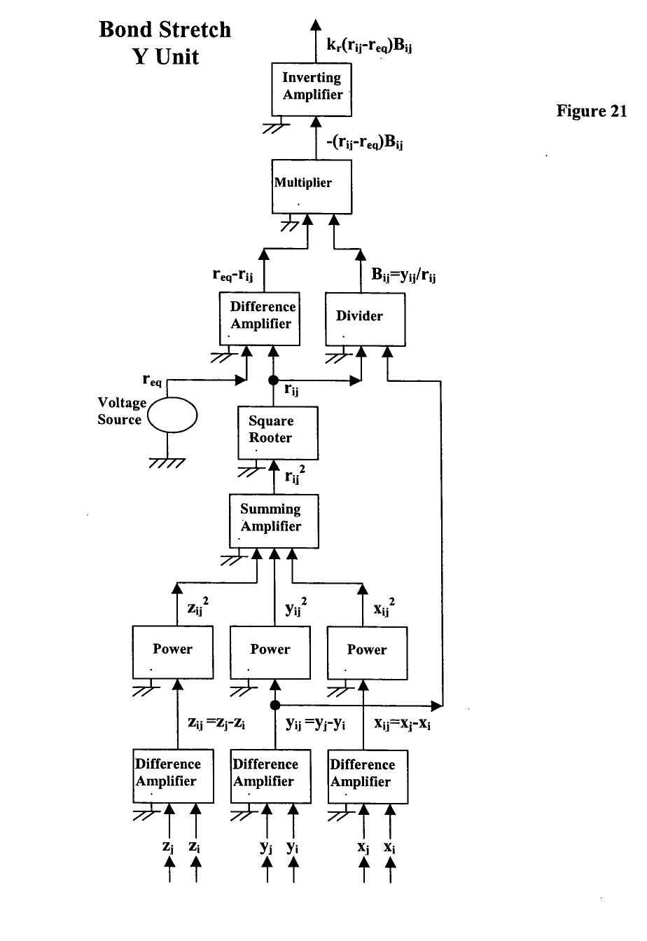

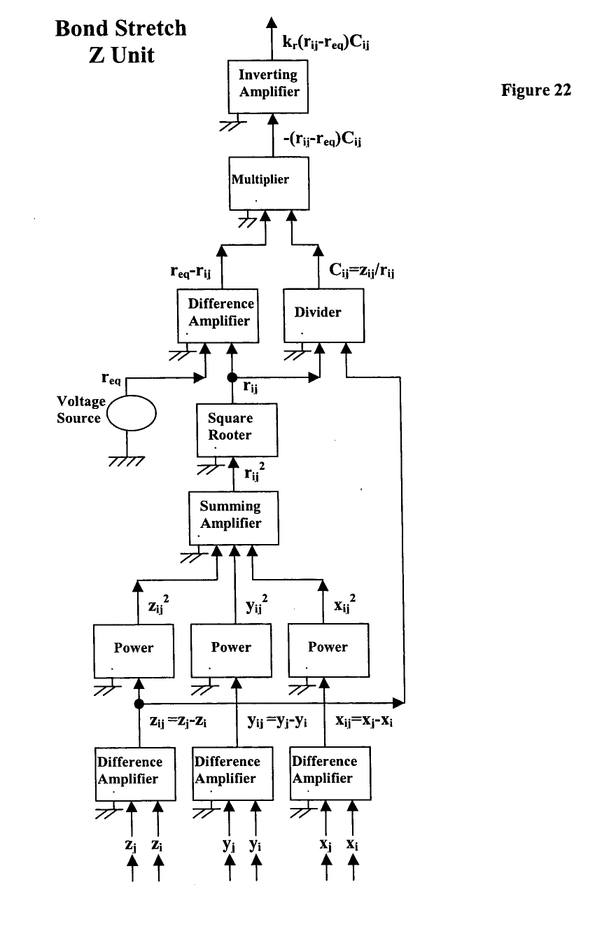

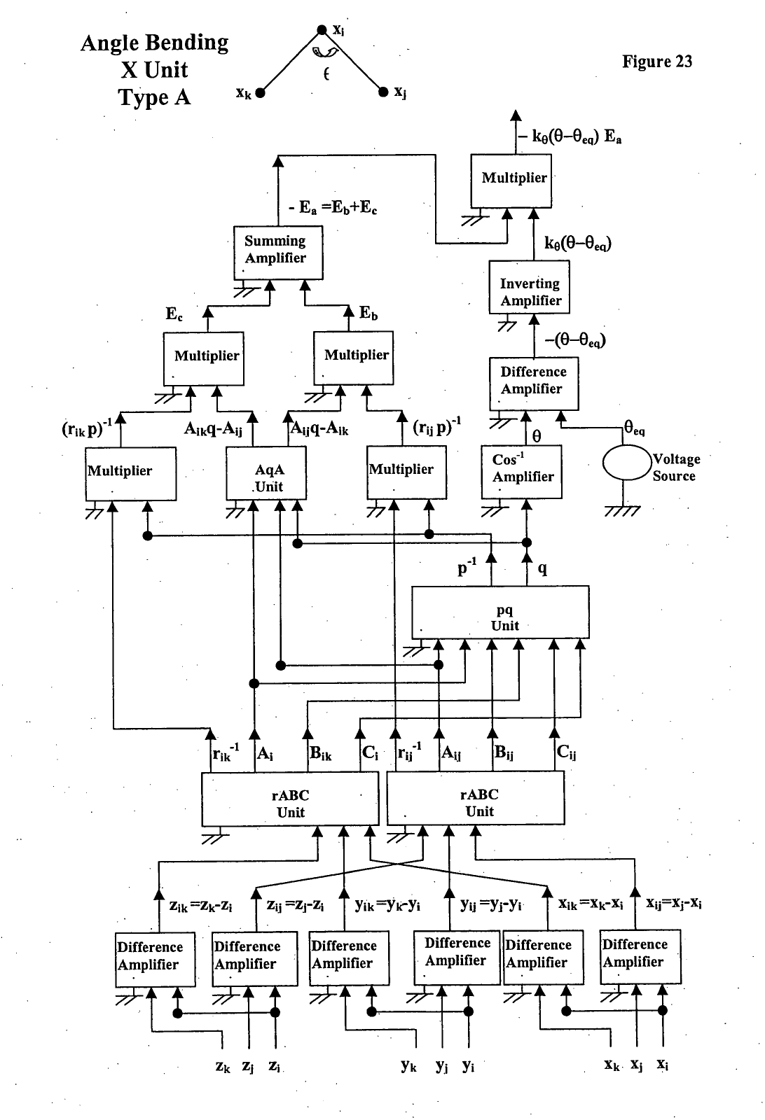

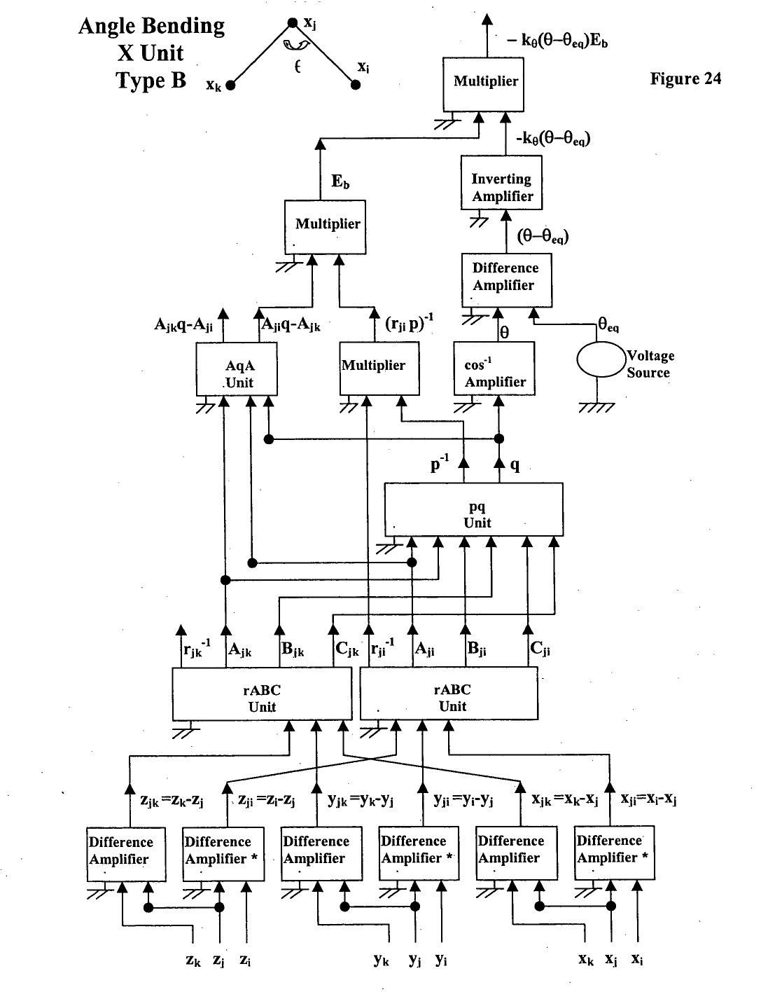

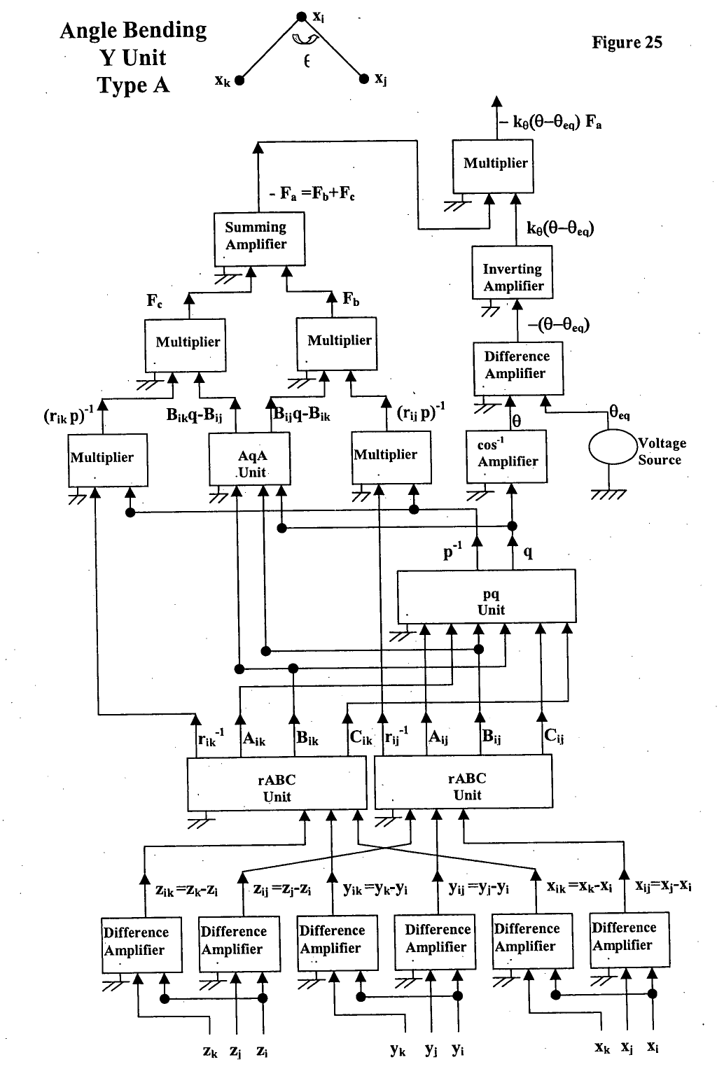

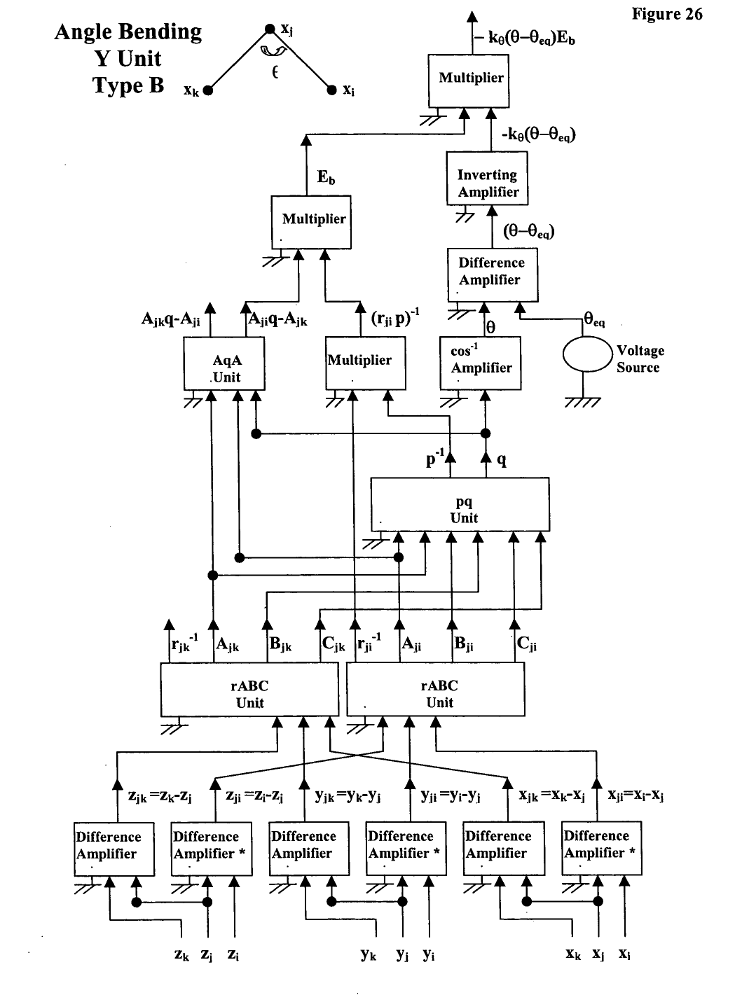

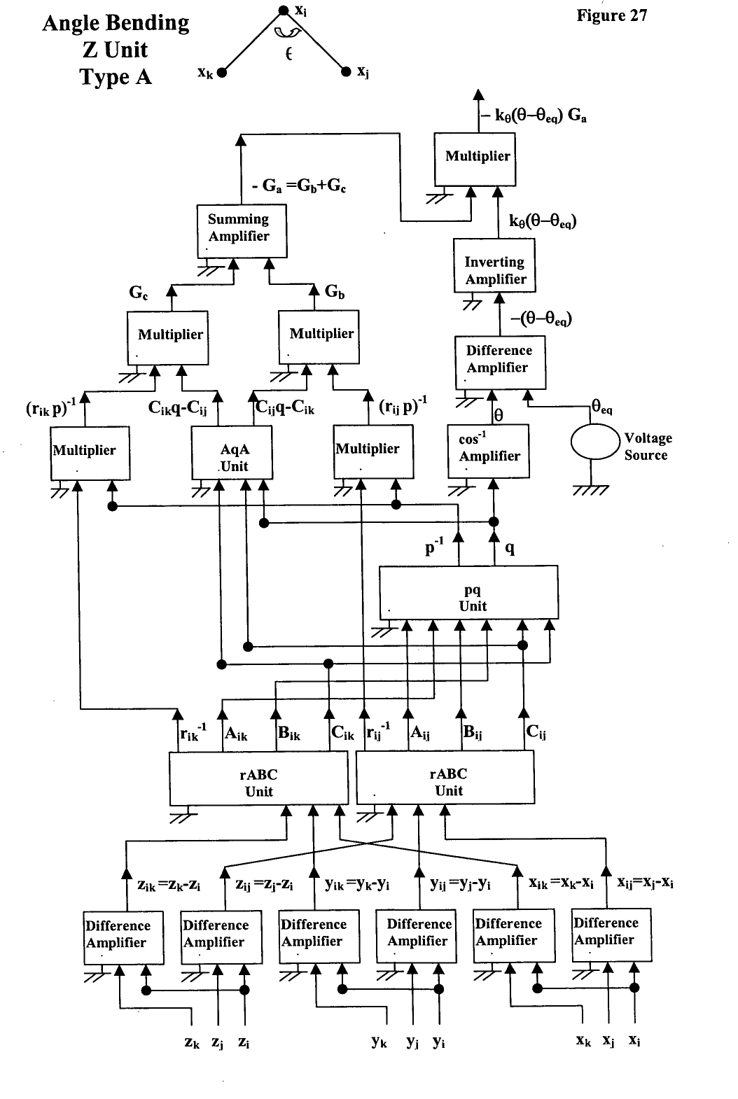

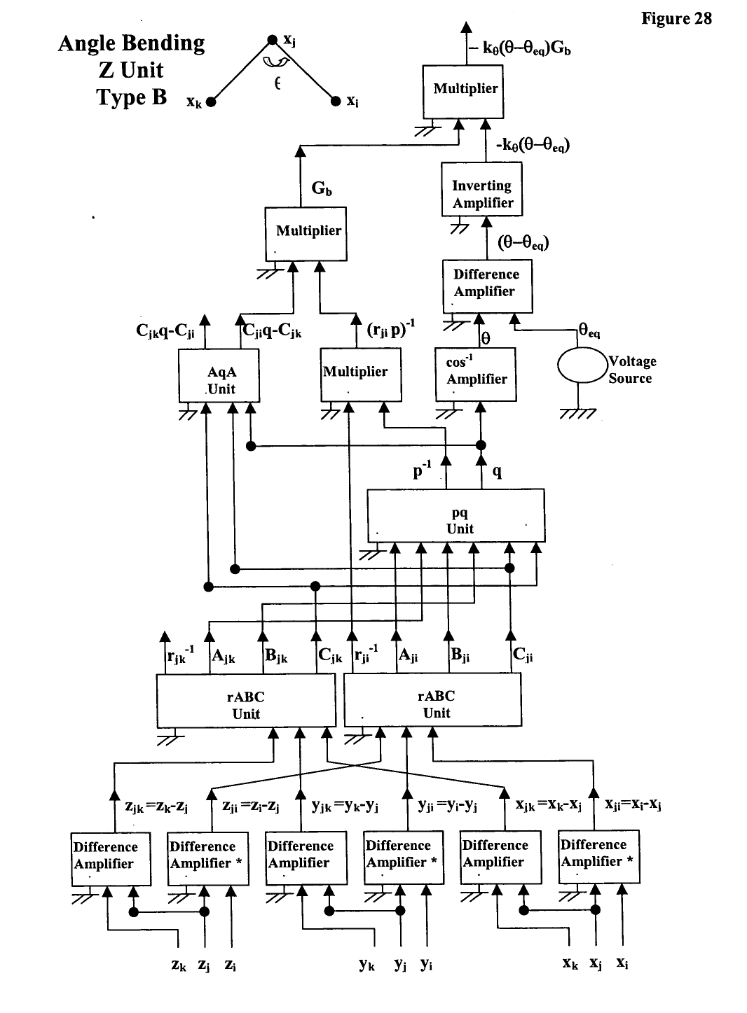

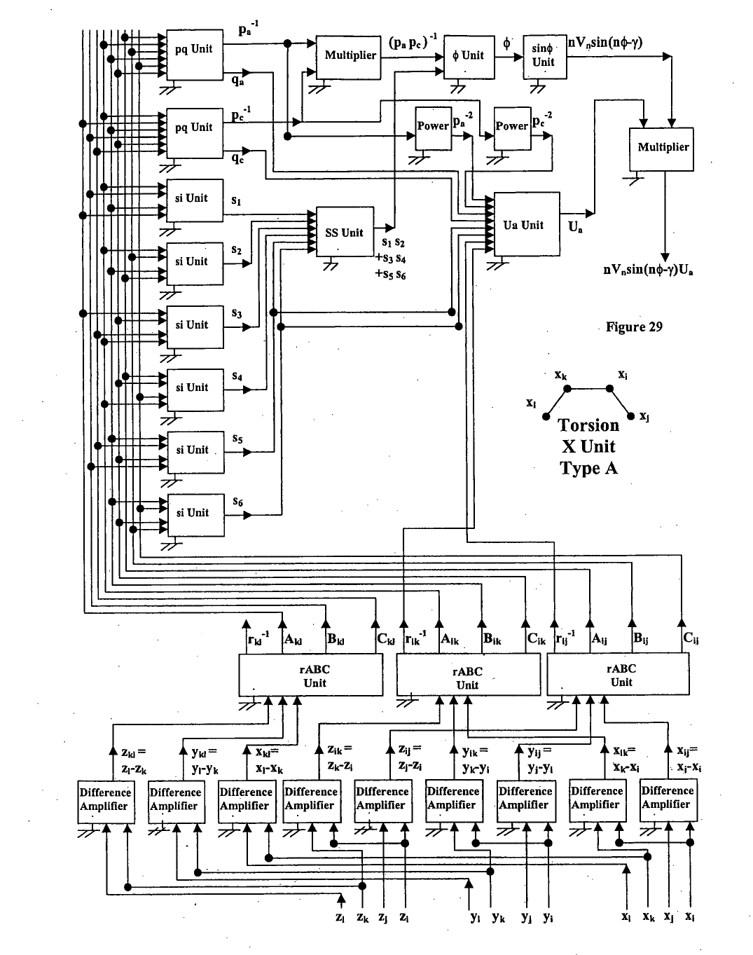

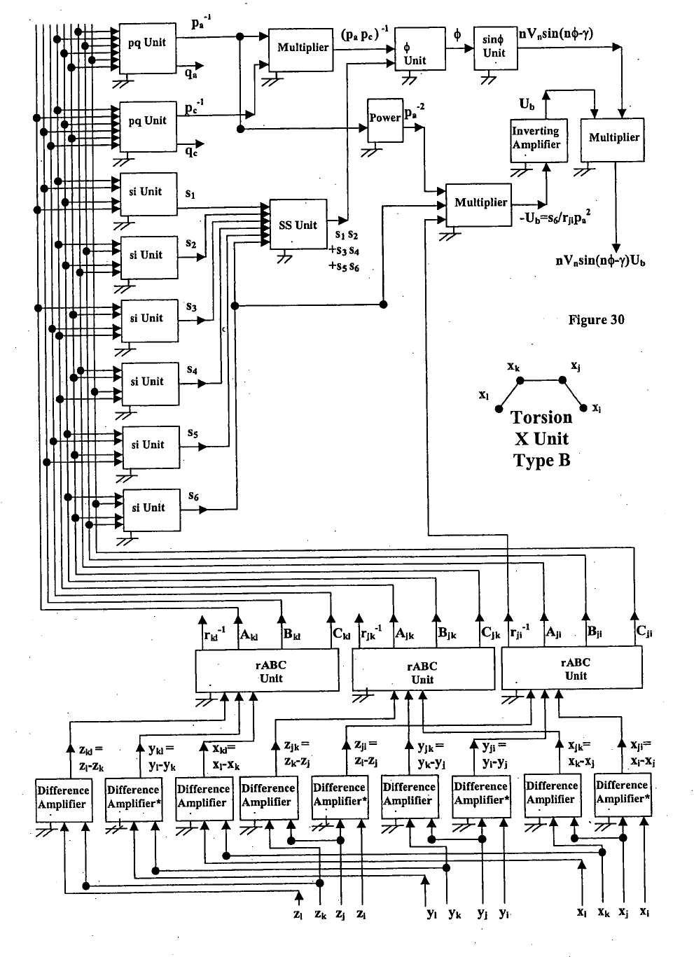

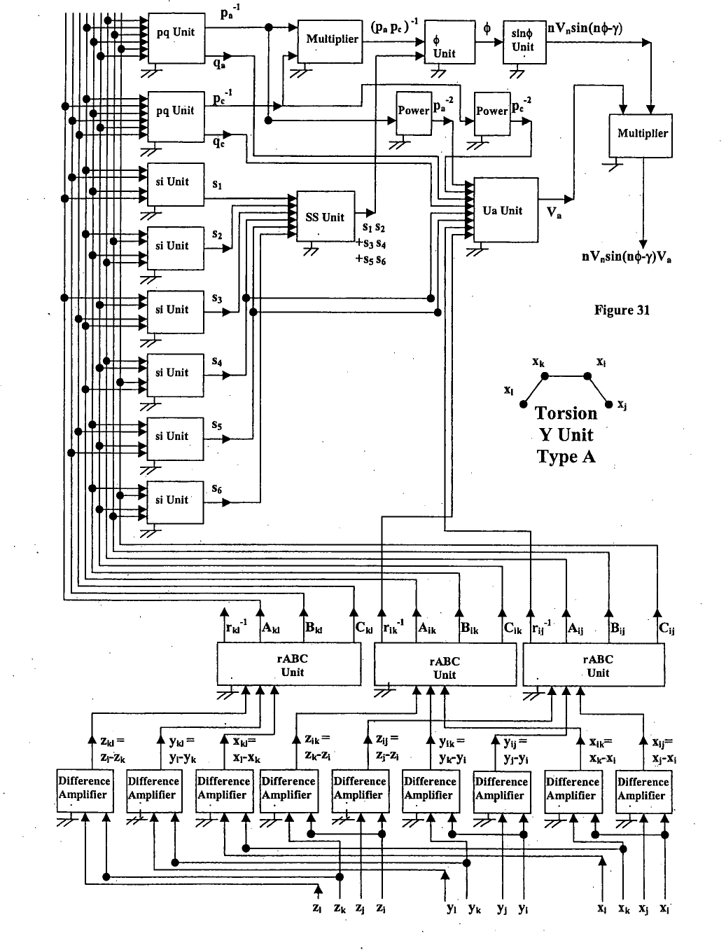

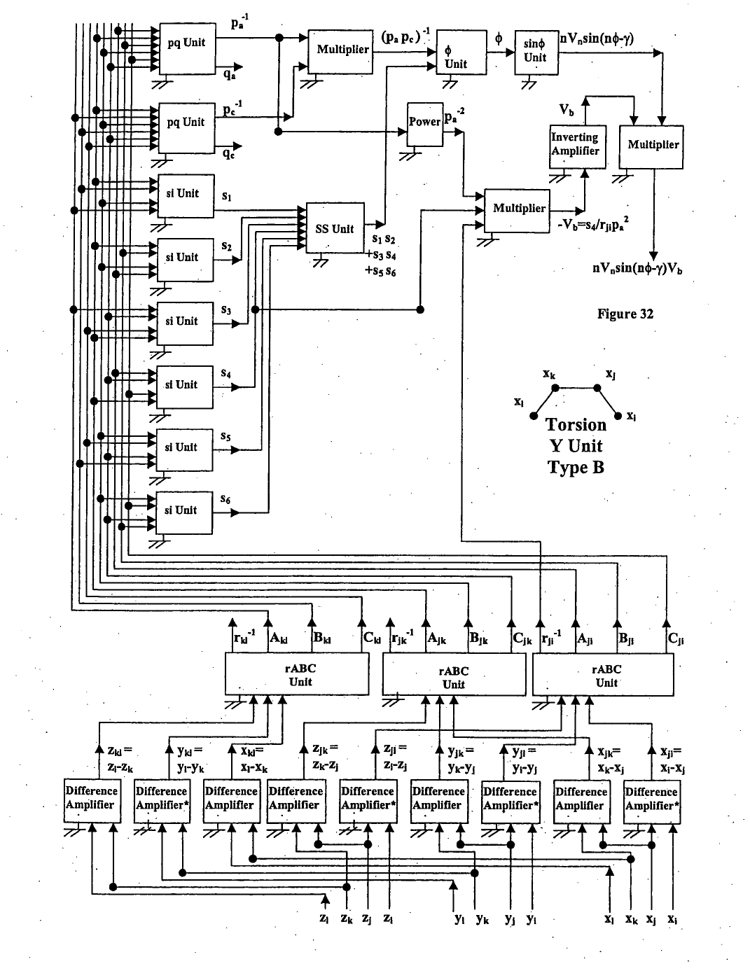

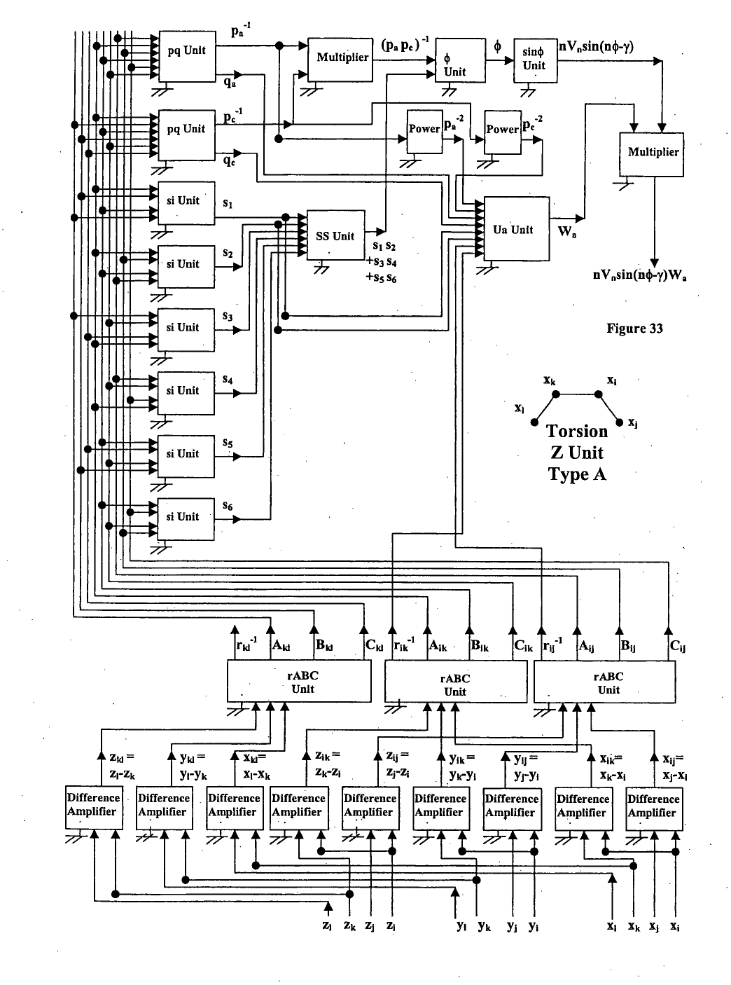

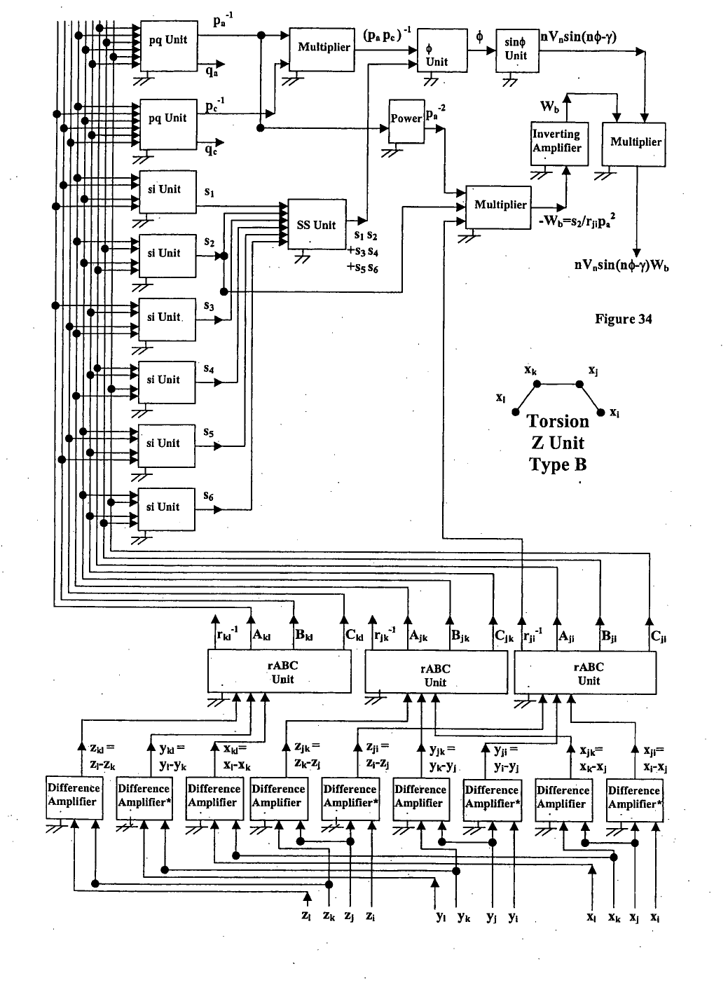

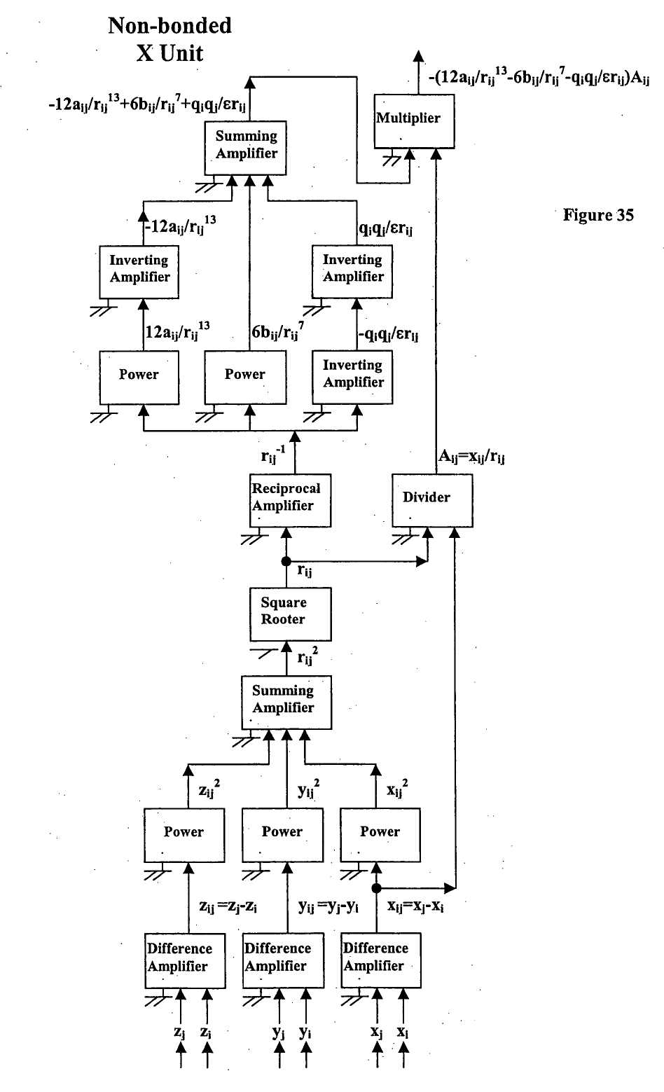

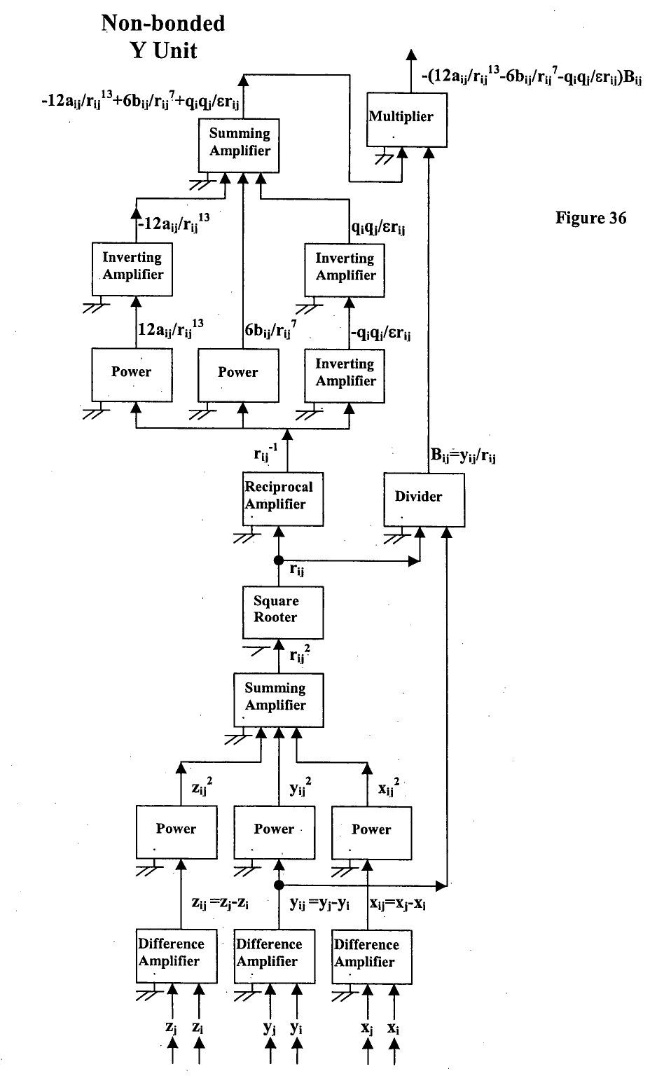

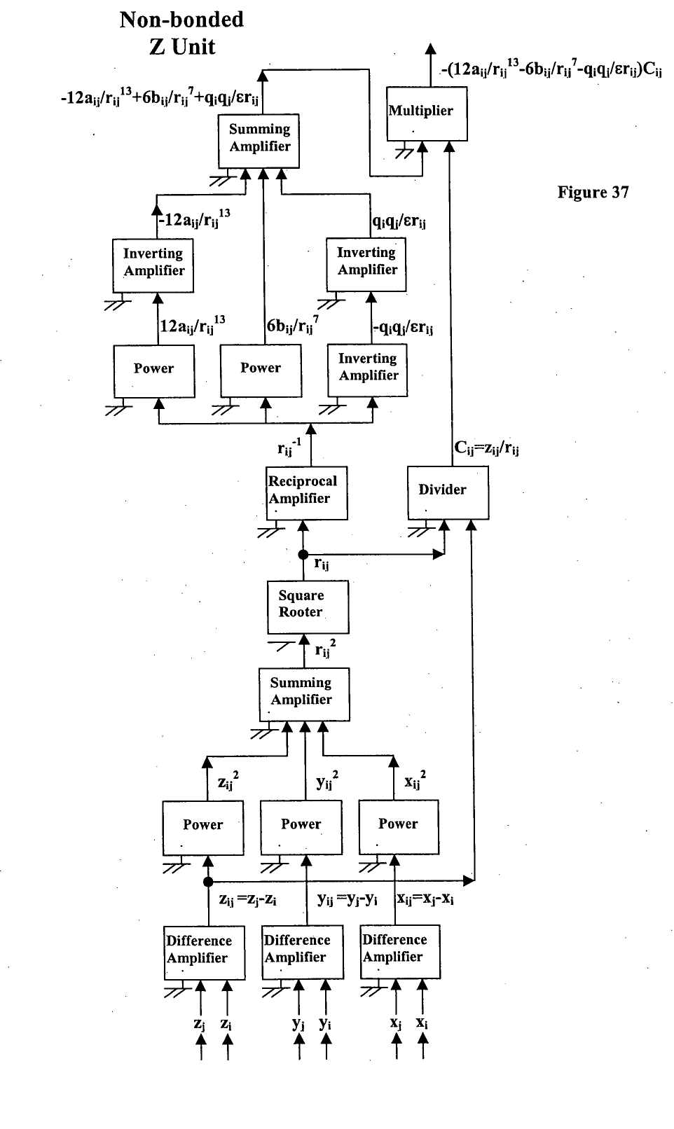

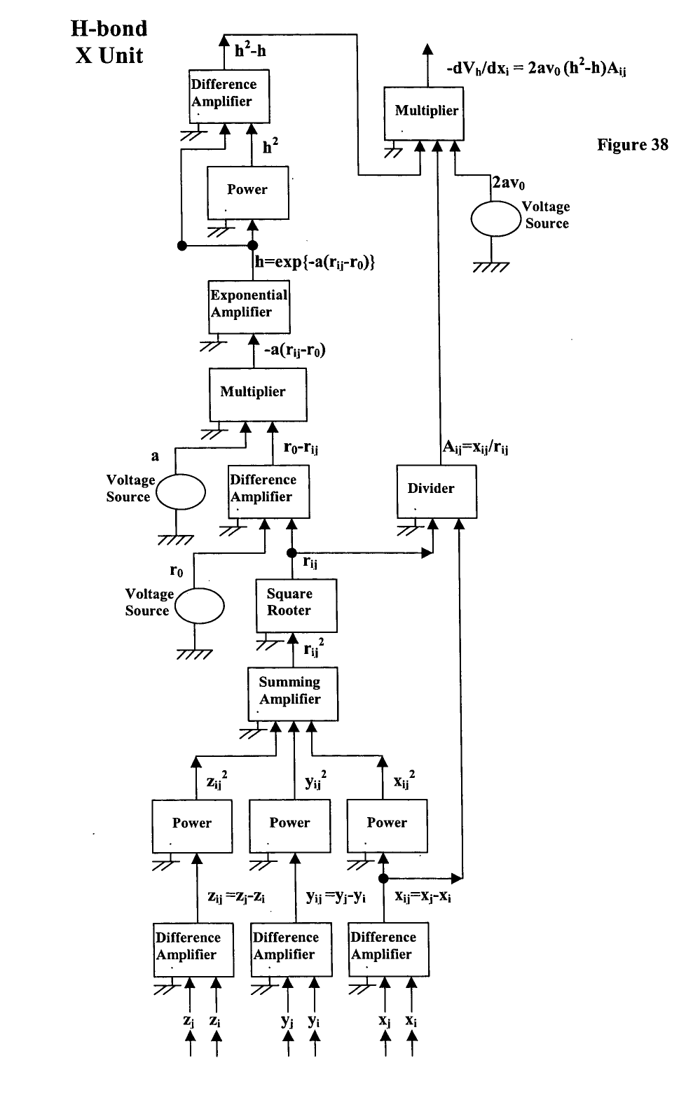

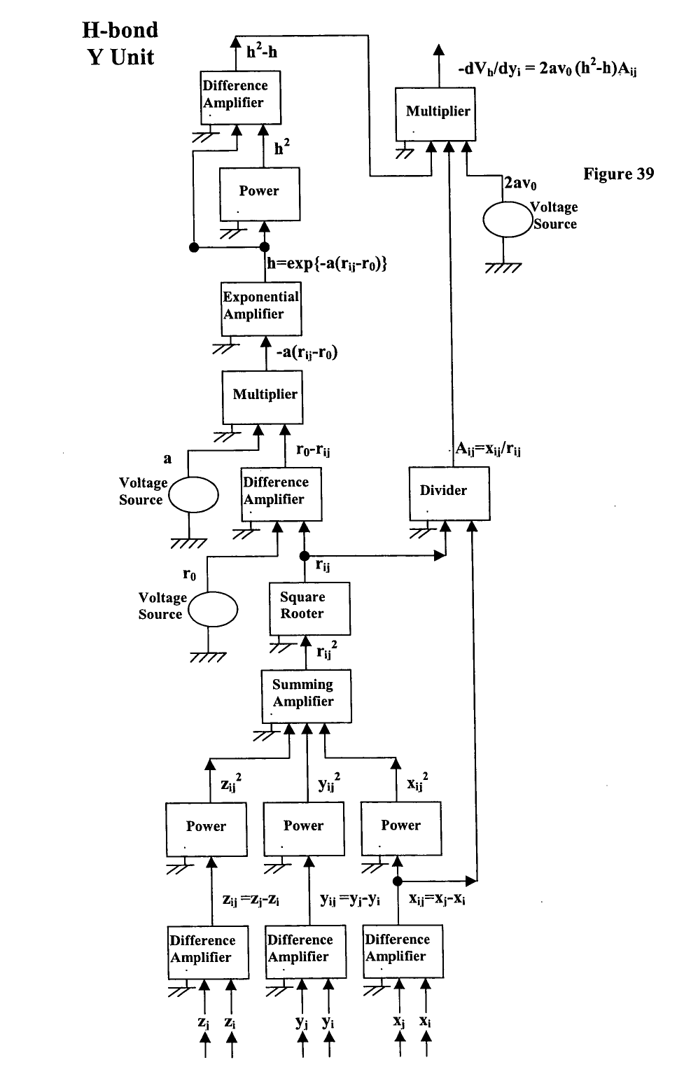

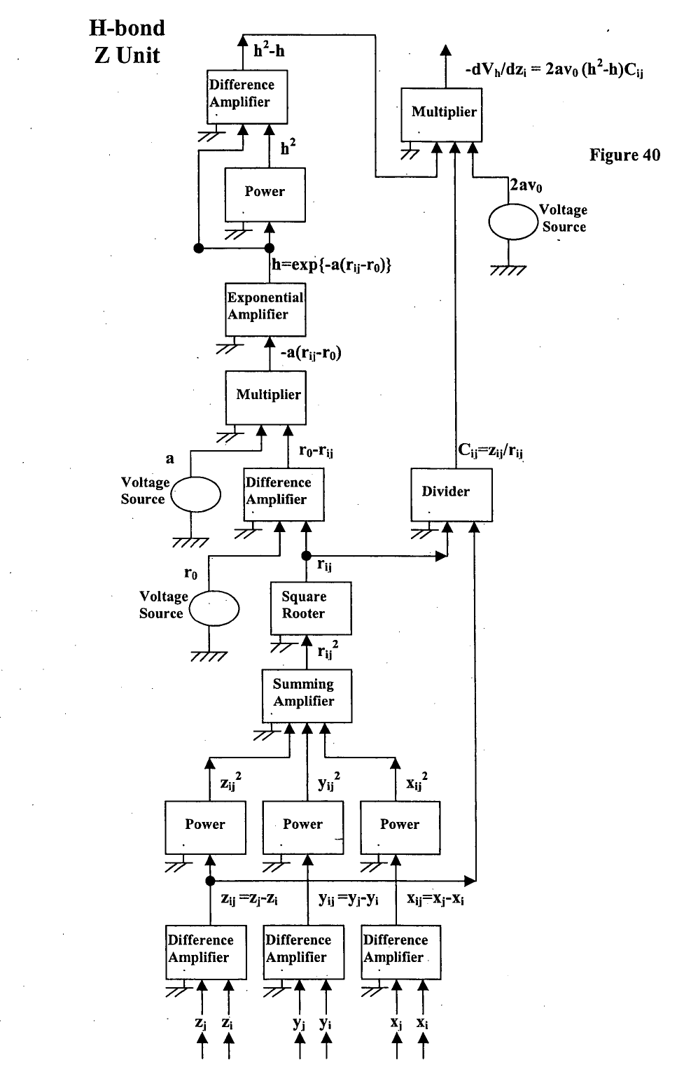

Referring now to FIG. 20 to FIG. 40, there are disclosed design plans for construction of special circuit units representing all possible terms of an ordinary differential equation associated with a biological or chemical reaction pathway. The operational amplifiers and random noise generator in these units are all described in the literature. The inverting amplifier and noninverting amplifier are described in “Electronic circuit analysis and design, 2^{nd} edition” D. A. Neamen, McGraw-Hill, 2001. The multiplier is described in “Fundamentals of linear circuits” T. L. Floyd, Macmillan Publishing Co. 1992. The exponentiator is described in “Function circuits: Design and applications” Y. J. Wong and W. E. Ott, McGram-Hill, 1976. The sine function amplifier is described in “Modern operational circuit design” J. I. Smith, Wiley-Interscience, 1971. The cos⁻¹ function amplifier can be generated in different ways. One example is the use of circuits of polynomials and another example is the use of circuits of non-integer exponent as described in “Function circuits: Design and applications” Y. J. Wong and W. E. Ott, McGram-Hill, 1976.

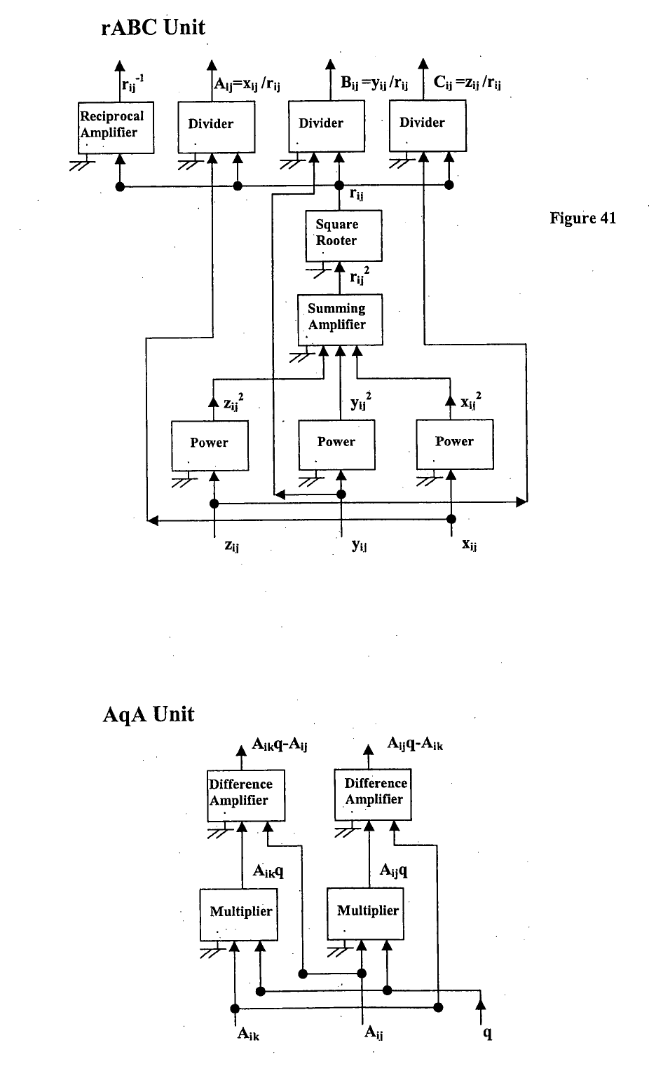

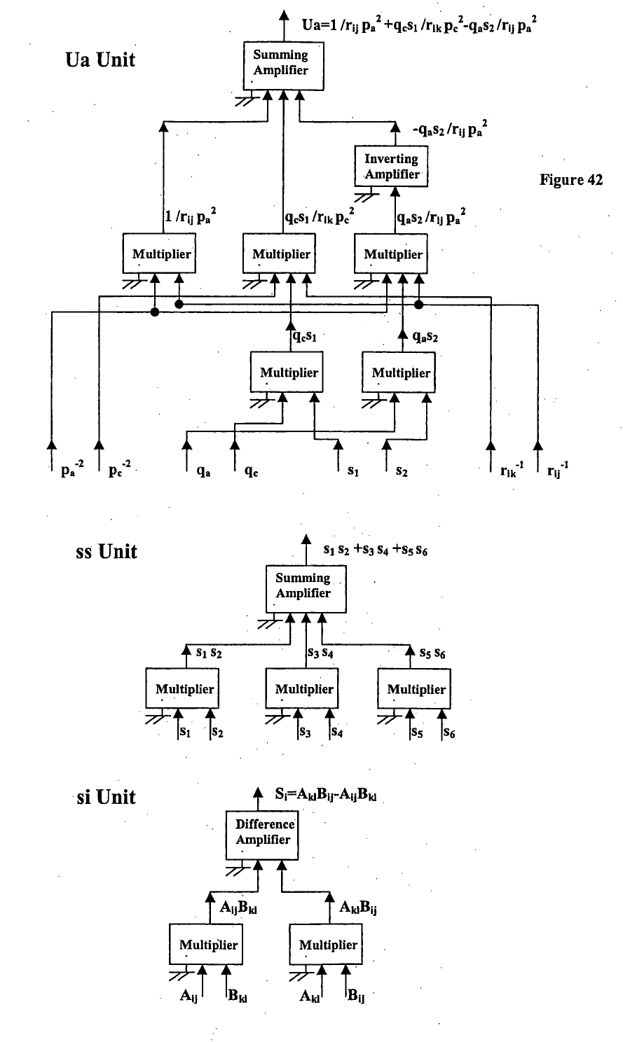

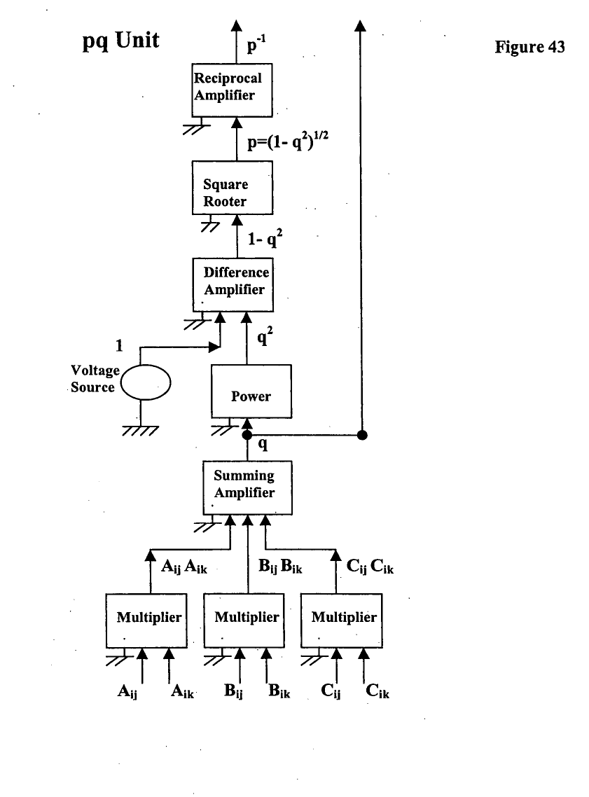

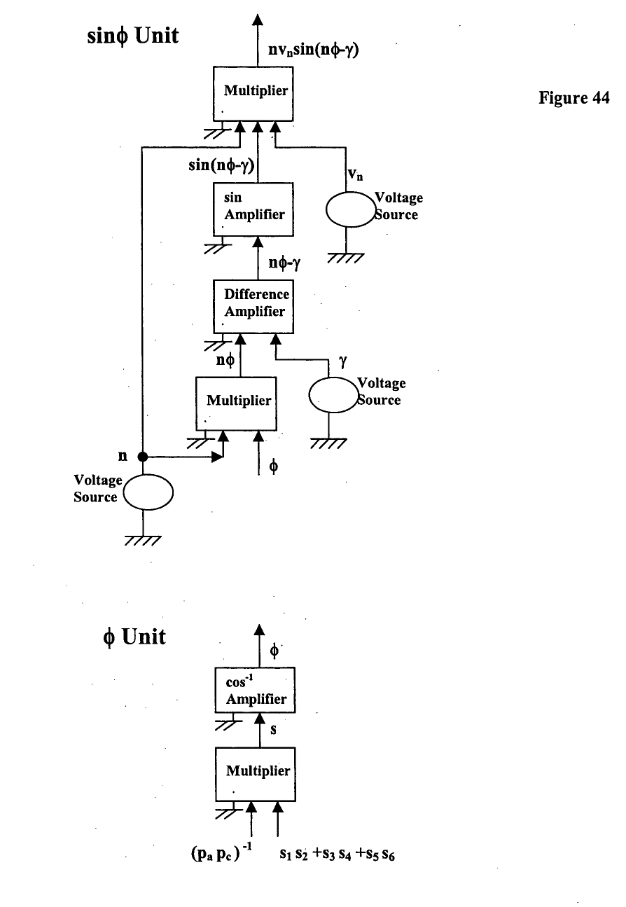

Some circuit units in FIG. 10 to FIG. 40 use one or more of the following specially introduced circuit sun-units: rABC unit, AqA unit, pq unit, Ua unit, ss unit, si unit, φ unit, sinφ unit. These sub-units are given in FIG. 41 to FIG. 44.

Methods for Maintaining the Voltages in the Circuits Within Allowed Range

In large proteins, the distance between two atoms can be larger than a few hundred angstroms. Thus the range of the xyz coordinates in these proteins may exceed the allowed voltages in a circuit. In addition, some terms in the molecular dynamics simulation equations can become very large if two atoms get too close or too far apart from each other, thereby causing the voltages at certain parts of the circuits to exceed the allowed range.

These problems can be solved by maintaining the voltage level in the circuit between two fixed voltage values, by using at least one of the following methods:
(1) Applying scaling factors to x, y, z coordinates and to the molecular dynamics equations so as to keep the x, y, z coordinates and each term in the equations within the allowed range.
This can be accomplished by multiplying one or two appropriately selected small numbers (non-zero real numbers) δ or δε to the Equation 3, Equation 4, and Equation 5.
(2) Resistors are used to scale-down the voltages at the input end of a segment of the circuits and amplifiers are used at the output end of the segment to scale-up the voltages to the proper level.
(3) Automatic gain control circuits can be added to the circuits to ensure the voltages are within the required range.
   Illustrative Example: Electronic Protein Emulator

Structural optimization and molecular dynamics of a protein can be described by a set of ODEs. An illustrative amino acid is governed by the collection of ODEs of each constituent atom (Equation 3-5). The circuit for each atom is illustrated in FIG. 10 to FIG. 12. The circuit group for all the atoms of an amino acid is illustrated in FIG. 13 to FIG. 15.

Illustrative Example: Electronic Nano-Molecular-System Emulator

There have been efforts for developing nano-molecular-systems. One example is a mimic of an enzyme ribonuclease shown in FIG. 16.

Structural optimization and molecular dynamics of such a nano-molecular-machine can be described by a set of ODEs. An illustrative sub-unit of cyclodextrin shown in FIG. 16(a) is governed by the collection of ODEs of each constituent atom (Equation 3-5). The circuit for each atom is illustrated in FIG. 10 to FIG. 12. The circuit group for all the atoms of a sub-unit is illustrated in FIG. 17 to FIG. 19.

1. A method for simulation of at least one biological and/or chemical reaction pathway comprising:
preparing a map of at least one biological and/or chemical reaction pathway;
constructing at least one set of binding and reaction equation from the pathway map;
constructing at least one set of concentration equation for molecules of the pathway map;
constructing an electronic circuit corresponding to every set of equation; and
determining simulation of pathway by measuring voltage at two or more connection points of the circuit.

2. The method of claim 1, wherein the binding, reaction and/or concentration equation is a linear or non-linear first- or second-order ordinary differential equation (ODE).

3. The method of claim 1, wherein the binding, reaction and/or concentration equation is a non-linear first-order ordinary differential equation (ODE).

4. The method of claim 1, wherein the electronic circuit comprises at least one of the following circuit units: linear protein/molecule concentration ±kxᵢ unit; protein/molecule concentration power ±kxᵢ^{a} unit; ligand-protein concentration product ±Lxᵢ unit; ligand-protein concentration power product ±kLxᵢ^{a} unit; protein-protein concentration product ±kxᵢxⱼ unit; protein-protein concentration power product ±kxᵢ^{a}xⱼ^{b} unit; stochastic rate constant generator unit that replaces a forward/reverse binding/reaction rate constant k by a stochastic value; and
wherein, k is a forward/reverse binding/reaction rate constant, L the concentration of a ligand, xᵢ and xⱼ are the concentration of protein/molecule xᵢ and xⱼ respectively, a and b are order of power of xᵢ and xⱼ.

5. The method of claim 1, further comprising maintaining the voltage level of the circuit between two fixed voltage values.

6. The method of claim 5, wherein the voltage level of the circuit is maintained between two fixed voltage values by:
multipling scaling factors to the concentration equation;
applying at least one resistor and/or amplifier at one or more connection point of the circuit, thereby scaling-down or scaling-up the voltage of one or more segment of the circuit; and/or applying automatic gain control circuits.

7. The method of claim 1, further comprising adding at least one unit circuit comprising an electronic random noise generator and/or a multiplicator amplifier at one or more connection point of the circuit.

8. The method of claim 1, further comprising determining the effect of at least one drug comprising adding at least one circuit unit associated with a receptor protein at one or more connection point of the circuit.

9. The method of claim 1, further comprising determining deficiency, mutation and/or deletion of at least one protein of the biological pathway, comprising setting a voltage ceiling, a voltage range and/or a fixed voltage at one or more connection point of the circuit.

10. The method of claim 1, wherein the biological pathway comprises at least one object, and wherein the object is protein, nucleic acid, ligand, substrate, inhibitor or antagonist, activator or agonist, reactant and/or reaction product.

11. An electronic circuit system for the simulation of at least one biological and/or chemical reaction pathway, comprising at least one electronic circuit representing a set of binding, reaction and/or concentration equation.

12. The electronic circuit system of claim 11, wherein the binding, reaction and/or concentration equation is a linear or non-linear first- or second-order ordinary differential equation (ODE).

13. The electronic circuit system of claim 11, wherein the electronic circuit comprises at least one the following circuit units: linear protein/molecule concentration ±kxᵢ unit; protein/molecule concentration power ±kxᵢ^{a} unit; ligand-protein concentration product ±Lxᵢ unit; ligand-protein concentration power product ±kLxᵢ^{a} unit; protein-protein concentration product ±kxᵢxⱼ unit; protein-protein concentration power product ±kxᵢ^{a}xⱼ^{b} unit; stochastic rate constant generator unit that replaces a forward/reverse binding/reaction rate constant k by a stochastic value; and
wherein, k is a forward/reverse binding/reaction rate constant, L the concentration of a ligand, xᵢ and xⱼ are the concentration of protein/molecule xᵢ and xⱼ respectively, a and b are order of power of xᵢ and xⱼ respectively.

14. A method for molecular dynamics simulation of biomolecules and/or nano-molecular systems comprising:
constructing at least one set of equation representing the molecular dynamics of at least one molecule of the biomolecules and/or the nano-molecular systems;
constructing an electronic circuit representing every set of equation; and
determining molecular dynamics simulation by measuring voltage at two or more connection points of the circuit.

15. The method of claim 14, wherein the equation is a linear or non-linear second order ordinary differential equation (ODE).

16. The method of claim 14, wherein the electronic circuit comprises at least one atom-position circuit unit, wherein the atom-position circuit unit represents the position of an atom of a molecule or a molecular system.

17. The method of claim 16, wherein the atom-position circuit unit comprises at least one atom-atom interaction circuit subunit, the atom-atom interaction circuit subunit representing a sub-unit of atom-atom interactions within a molecule or a molecular system and comprising at least one of: internal bond stretch, angle bending, torsion, non-bonded unit; bond stretch, angle bending, and torsion unit; between at least two nearest sub-unit of a molecule.

18. The method of claim 17, wherein each atom-atom interaction circuit subunit represents a term in the molecular dynamics equation, and wherein the atom-atom interaction circuit subunit comprises at least one of the following: bond stretch x unit, bond stretch y unit, bond stretch z unit, angle bending x type-A unit, angle bending x type-B unit, angle bending y type-A unit, angle bending y type-B unit, angle bending z type-A unit, angle bending z type-B unit, torsion x type-A unit, torsion x type-B unit, torsion y type-A unit, torsion y type-B unit, torsion z type-A unit, torsion z type-B unit, non-bonded x unit, non-bonded y unit, non-bonded z unit, hydrogen-bond x unit, hydrogen-bond y unit, and hydrogen-bond z unit; and
wherein x, y, and z represent the coordinates of each atom of the molecule, and type-A represents the case of the atom being in the middle-position of an angle bending or torsion connection with other atoms, and type-B represents the case of the atom being in the end-position of an angle bending or torsion connection with other atoms.

19. The method of claim 14, further comprising maintaining the voltage level in the circuit between two fixed voltage values.

20. The method of claim 19, wherein x, y and z represent the coordinate of the molecule, and the voltage level of the circuit is maintained between two fixed voltage values by:
applying scaling factors to the x, y and z coordinates and to the molecular dynamic equation;
applying at least one resistor and/or amplifier at one or more connection point of the circuit, thereby scaling-down or —up the voltage of one or more segment of the circuit; and/or
applying automatic gain control circuits.

21. The method of claim 14, wherein the biomolecule comprises amino acids, nucleotides and/or organic molecules.

22. A circuit group representing the interaction pattern in the chemical structure of a molecule or a sub-unit of interaction pattern in the chemical structure of a molecule comprising:
a bond stretch connection between each atom pair of the molecule covalently bonded to each other;
an angle bending connection pair between a first atom and other two atoms;
a torsion connection bundle between a first atom and other three atoms; and
a non-bonded connection between each atom pair whose atoms are at least four bonds away from each other.

23. A circuit unit comprising at least one circuit group of claim 22.

24. An electronic circuit comprising at least one circuit unit, the circuit unit comprising at least one circuit group, the circuit group representing a sub-unit of interaction pattern in the chemical structure of a molecule and comprising internal bond stretch, angle bending, torsion, non-bonded units; and/or bond stretch, angle bending, and/or and torsion units; between at least two nearest sub-unit of a molecule.

25. The electronic circuit of claim 24, wherein each circuit unit represents a term in the molecular dynamic equation, and wherein the circuit unit comprises at least one of the following: bond stretch x unit, bond stretch y unit, bond stretch z unit, angle bending x type-A unit, angle bending x type-B unit, angle bending y type-A unit, angle bending y type-B unit, angle bending z type-A unit, angle bending z type-B unit, torsion x type-A unit, torsion x type-B unit, torsion y type-A unit, torsion y type-B unit, torsion z type-A unit, torsion z type-B unit, non-bonded x unit, non-bonded y unit, non-bonded z unit, hydrogen-bond x unit, hydrogen-bond y unit, and hydrogen-bond z unit; and wherein x, y, and z represent the coordinates of each atom of the molecule, and type-A unit represents the case of the atom being in the middle-position of an angle bending or torsion connection with other atoms, and type-B represents the case of the atom being in the end-position of an angle bending or torsion connection with other atoms.

26. A method for the manufacture of an electronic circuit representing at least one biomolecule and/or nano-molecular system, the electronic circuit comprising at least a unit circuit comprising at least a circuit group, wherein the circuit group represents a sub-unit of interaction pattern in the chemical structure of a molecule or a molecular system comprising:
introducing a bond stretch between each atom of a pair of atoms covalently bonded to each other;
introducing an angle bending connecting pair between a first atom and other two atoms;
introducing a torsion connection bundle between a first atom and other three atoms; and
introducing a non-bonded connection between each atom pair whose atoms are at least four bonds away from each other.
